(19) United States
(12) Patent Application Publication
(10) Pub. No.: US 2026/0280746 A1
(43) Pub. Date: Sep. 17, 2026

(54) METHODS AND APPARATUS FOR MULTIPLEXING AND DEMULTIPLEXING OPTICAL SIGNALS OF PROTECTED OPTICS

(71) Applicant: Molex, LLC, Lisle, IL (US)

(72) Inventors: Mark Edward Boduch, Woodstock, IL (US); Lifu Gong, San Jose, CA (US); Kesheng Xu, San Ramon, CA (US); Feng Qing Zhou, San Jose, CA (US); Jinyuan Qiao, Cupertino, CA (US)

(21) Appl. No.: 19/566,512

(22) Filed: Mar. 13, 2026

Related U.S. Application Data
(60) Provisional application No. 63/773,379, filed on Mar. 17, 2025.

(51) Int. Cl. H04J 14/02; H04B 10/03

(52) U.S. Cl. CPC H04J 14/0291; H04B 10/03

(57) ABSTRACT

An optical apparatus may include a set of primary optical transceivers configured to generate a set of primary wavelengths and one or more redundant optical transceivers configured to generate a set of replacement wavelengths. The optical apparatus may include a multiplexer coupled to the primary and redundant optical transceivers via first protection optics. The first protection optics may be configured to replace a primary wavelength from a primary optical transceiver with a replacement wavelength from the one or more redundant optical transceivers when the primary optical transceiver fails. The optical apparatus may include a demultiplexer coupled to the primary and redundant optical transceivers via second protection optics. The second protection optics may be configured to forward a wavelength from the wavelength demultiplexer to one of the one or more redundant optical transceivers instead of one of the primary optical transceivers when the one of the primary optical transceivers fails.

### FIELD OF THE DISCLOSURE

This disclosure is directed to methods and apparatus of multiplexing and demultiplexing optical signals of protected optical transceivers. More specifically, the disclosure is directed to an optical apparatus having redundant optical transceivers to protect against one or more optical transceiver failures over the lifetime of the optical apparatus.

### BACKGROUND

As the amount of bandwidth transported between physical sites increases, the optical equipment required for such transport will require greater degrees of integration to simplify the deployment of such equipment. This integration includes the integration of the optical transceivers needed to transmit and receive the wavelengths carrying the bandwidth between sites, as well as the demultiplexer and multiplexer optics used to demultiplex and multiplex the wavelengths to and from the optical transceivers. This integration may be such that each individual optical transceiver may not be field replaceable. There is a need in the art for backup optical transceivers that may automatically replace individual optical transceivers when they fail. This has the advantage of quickly restoring the bandwidth associated with a failed optical transceiver, as the bandwidth restoration using the backup optical transceivers can be accomplished without human intervention. Further, to perform the bandwidth restoration, optical protection mechanisms are needed. These optical protection mechanisms will reside between the optical transceivers and the wavelength multiplexing and demultiplexing optics.

Since the optical power levels of transmitted wavelengths decrease over distance, optical amplifiers are used to amplify the power of the wavelengths in a transmission network. However, amplification adds noise to the optical wavelengths, which makes recovery of the signals at the end point optical transceivers more difficult. Therefore, it's important to limit the amplification. To help limit the amplification, the optical gain of the optical amplifiers used at the wavelength multiplexing and demultiplexing sites should be minimized. Since optical gain is required to overcome the optical insertion loss of the optical protection mechanisms and the multiplexing and demultiplexing optics, it's highly beneficial to keep the optical insertion loss of the optical protection mechanisms and the multiplexing and demultiplexing optics to a minimum. Therefore, there is a need in the art for low insertion-loss protection optics coupled with low insertion loss multiplexers and demultiplexers.

### SUMMARY OF THE DISCLOSURE

Example embodiments of the present disclosure relate to an optical apparatus, comprising at least one optical protection group, the at least one optical protection group comprising at least two primary optical transceivers, at least one redundant optical transceiver, and protection optics; and a wavelength multiplexer used to multiplex a plurality of wavelengths from the at least one optical protection group, wherein the protection optics substitute a first wavelength from one of the at least two primary optical transceivers with a second wavelength from the at least one redundant optical transceiver when one of the at least two primary optical transceivers fails, and wherein the protection optics comprise at least one thin-film filter (TFF) used to distribute the second wavelength from the at least one redundant optical transceiver. The protection optics may comprise at least two optical switches connected to the at least one TFF and used to substitute the first wavelength from one of the at least two primary transceivers with the second wavelength. Alternatively (instead of the two optical switches), the protection optics may comprise at least two optical couplers connected to the at least one TFF and used to substitute the first wavelength from one of the at least two primary transceivers with the second wavelength.

Example embodiments of the present disclosure further relate to an optical apparatus, comprising a multiplexer; protection optics; a plurality of primary optical transceivers coupled to the multiplexer and used to generate a plurality of primary wavelengths; and a plurality of redundant optical transceivers coupled to the multiplexer and used to generate a plurality of replacement wavelengths, wherein the protection optics replace one of the plurality of primary wavelengths with one of the plurality of replacement wavelengths when one of the plurality of primary optical transceivers fails. Additionally, one of the plurality of replacement wavelengths from one of the plurality of redundant optical transceivers may replace one of the plurality of primary wavelengths of one of two of the plurality of primary optical transceivers. Additionally, one of the plurality of replacement wavelengths from two of the plurality of redundant optical transceivers may replace one of the plurality of primary wavelengths of one of four of the plurality of primary optical transceivers.

Example embodiments of the present disclosure further relate to an optical apparatus, comprising a demultiplexer having a plurality of output ports outputting a plurality of wavelengths; a plurality of primary optical transceivers; a plurality of redundant optical transceivers; and protection optics, wherein the protection optics forward the plurality of wavelengths to the plurality of primary optical transceivers and the plurality of redundant optical transceivers, wherein the protection optics comprise at least one TFF, and at least two selected, independently, from the group consisting of an optical switch, an optical coupler, and combinations thereof.

Example embodiments of the present disclosure further relate to an optical apparatus, comprising: a wavelength multiplexer; a plurality of primary optical transceivers coupled to the wavelength multiplexer and configured to generate a plurality of primary wavelengths; one or more redundant optical transceivers coupled to the wavelength multiplexer and configured to generate a plurality of replacement wavelengths; and first protection optics, wherein the plurality of primary optical transceivers and the one or more reductant optical transceivers are coupled to the wavelength multiplexer via the first protection optics, and wherein the first protection optics are configured to replace a primary wavelength from a primary optical transceiver in the plurality with a replacement wavelength from the one or more redundant optical transceivers when the primary optical transceiver fails.

Example embodiments of the present disclosure further relate to an optical apparatus, comprising: a wavelength demultiplexer configured to output a plurality of wavelengths; a plurality of primary optical transceivers coupled to the wavelength demultiplexer; one or more redundant optical transceivers coupled to the wavelength demultiplexer; and first protection optics, wherein the plurality of primary optical transceivers and the one or more reductant optical transceivers are coupled to the wavelength demultiplexer via the first protection optics, and wherein the first protection optics are configured to: forward the plurality of wavelengths to the plurality of primary optical transceivers; and forward a wavelength from the wavelength demultiplexer to one of the one or more redundant optical transceivers instead of one of the plurality of primary optical transceivers when the one of the plurality of primary optical transceivers fails.

Example embodiments of the present disclosure further relate to a method for optical communications at an optical apparatus comprising a multiplexer, a plurality of primary optical transceivers, one or more redundant optical transceivers, and first protection optics, the method comprising: generating a plurality of primary wavelengths using the plurality of primary optical transceivers for output to the multiplexer; detecting that a primary optical transceiver of the plurality of primary optical transceivers failed; replacing, using the first protection optics and based on the detecting, a primary wavelength associated with the failed primary optical transceiver with a replacement wavelength from the one or more redundant optical transceivers; and outputting the replacement wavelength to the multiplexer.

Example embodiments of the present disclosure further relate to an optical apparatus, comprising: a wavelength multiplexer configured to multiplex a plurality of wavelengths; a protection group comprising four primary optical transceivers and two redundant optical transceivers; and protection optics configured to couple the four primary optical transceivers and the two redundant optical transceivers to the wavelength multiplexer, wherein the protection optics comprise a plurality of cascaded thin-film filters and a plurality of optical switches, wherein at least one thin-film filter of the plurality of cascaded thin-film filters is configured to transmit a first group of wavelengths from the plurality and reflect a second group of wavelengths from the plurality, and wherein the first group of wavelengths and the second group of wavelengths are separated in wavelength by at least one skipped wavelength from the plurality that is excluded from the first group of wavelengths and from the second group of wavelengths.

Example embodiments of the present disclosure further relate to an optical apparatus, comprising: a wavelength multiplexer; and at least one optical protection group coupled to the wavelength multiplexer, the at least one optical protection group comprising: at least two primary optical transceivers configured to generate primary wavelengths for output to the wavelength multiplexer, at least one redundant optical transceiver configured to generate replacement wavelengths, and protection optics configured to substitute, based on a failure of one of the at least two primary optical transceivers, a replacement wavelength for a primary wavelength configured to be output by the failed primary optical transceiver, wherein the protection optics comprise: at least two redundant wavelength enable components associated with the at least two primary optical transceivers; and at least one thin-film filter configured to receive the replacement wavelength from the at least one redundant optical transceiver and distribute the replacement wavelength to a redundant wavelength enable component of the at least two redundant wavelength enable components that is associated with the failed primary optical transceiver, wherein the redundant wavelength enable component is configured to selectively forward one of the primary wavelength and the replacement wavelength to the wavelength multiplexer.

### BRIEF DESCRIPTION OF THE DRAWINGS

To assist in understanding the present disclosure, reference is now made to the following description taken in conjunction with the accompanying drawings, in which:

FIG. 1 depicts an optical network in accordance with some embodiments of the present disclosure.

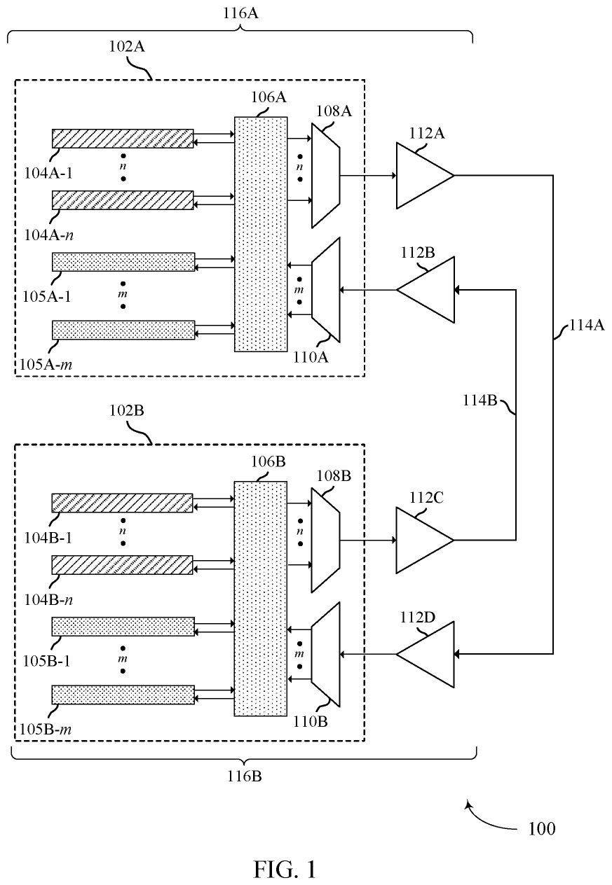

FIG. 2 depicts a portion of an optical transmission system showing protection optics for use with a multiplexer in accordance with some embodiments of the present disclosure.

FIG. 3 depicts a portion of an optical transmission system showing protection optics for use with a multiplexer in accordance with some embodiments of the present disclosure.

FIG. 4 depicts a portion of an optical transmission system showing protection optics for use with a multiplexer in accordance with some embodiments of the present disclosure.

FIG. 5 depicts a thin film filter (TFF) network in accordance with some embodiments of the present disclosure.

FIG. 6 depicts a portion of an optical transmission system showing protection optics for use with a multiplexer in accordance with some embodiments of the present disclosure.

FIG. 7 depicts a portion of an optical transmission system showing protection optics for use with a multiplexer in accordance with some embodiments of the present disclosure.

FIG. 8 depicts a portion of an optical transmission system showing protection optics for use with a multiplexer in accordance with some embodiments of the present disclosure.

FIG. 9 depicts a portion of an optical transmission system showing protection optics for use with a multiplexer in accordance with some embodiments of the present disclosure.

FIGS. 10A, 10B, 10C, and 10D depict various embodiments of multiplexers and demultiplexers in accordance with some embodiments of the present disclosure.

FIG. 11 depicts a portion of an optical transmission system showing protection optics for use with a demultiplexer in accordance with some embodiments of the present disclosure.

FIG. 12 depicts a portion of an optical transmission system showing protection optics for use with a demultiplexer in accordance with some embodiments of the present disclosure.

FIG. 13 depicts a portion of an optical transmission system showing protection optics for use with a demultiplexer in accordance with some embodiments of the present disclosure.

FIG. 14 depicts a portion of an optical transmission system showing protection optics for use with a demultiplexer in accordance with some embodiments of the present disclosure.

FIG. 15 depicts a portion of an optical transmission system showing protection optics for use with a multiplexer in accordance with some embodiments of the present disclosure.

FIG. 16 depicts a portion of an optical transmission system showing protection optics for use with a demultiplexer in accordance with some embodiments of the present disclosure.

FIG. 17 depicts a portion of an optical transmission system showing protection optics for use with a multiplexer in accordance with some embodiments of the present disclosure.

FIG. 18 depicts an optical transmission system in accordance with some embodiments of the present disclosure.

FIG. 19 depicts an optical transmission system in accordance with some embodiments of the present disclosure.

### DETAILED DESCRIPTION

An optical wavelength multiplexer and demultiplexer along with various optical transceiver protection schemes using simple optical components are disclosed herein. For the purposes of this patent application, an optical transceiver is defined as a device that can generate and receive at least one specific wavelength within a band of wavelengths such as the International Telecommunication Union (ITU) defined C-band. A given optical transceiver may be able to generate a single predetermined wavelength within the band of wavelengths (referred to as a fixed wavelength optical transceiver), or a given optical transceiver may be able generate a single wavelength over a narrow sub-band of the band of wavelengths (referred to as a narrowly tunable optical transceiver), or a given optical transceiver may be able to generate any wavelength within the band of wavelengths (referred to as fully tunable optical transceiver). Optical transceiver protection schemes provide a mechanism to substitute a failed optical transceiver with a backup (or redundant) optical transceiver.

depicts an optical network 100 in accordance with some embodiments of the present disclosure. The optical network 100 comprises two physical sites 116A, 116B, each site containing an optical apparatus 102A, 102B with optical transceivers, protection optics 106A, 106B, an optical wavelength multiplexer 108A, 108B, and an optical wavelength demultiplexer 110A, 110B. The optical apparatuses may be used to multiplex and demultiplex optical signals of protected optical transceivers.

As shown in, a given optical apparatus 102A, 102B comprises n primary optical transceivers, m redundant optical transceivers, protection optics, an optical wavelength multiplexer with n inputs, and an optical wavelength demultiplexer with n outputs. For example, the optical apparatus 102A may include n primary optical transceivers 104A-1 through 104A-n, m redundant optical transceivers 105A-1 through 105A-m, protection optics 106A, an optical wavelength multiplexer 108A, and an optical wavelength demultiplexer 110A. The optical apparatus 102B may include n primary optical transceivers 104B-1 through 104B-n, m redundant optical transceivers 105B-1 through 105B-m, protection optics 106B, an optical wavelength multiplexer 108B, and an optical wavelength demultiplexer 110B.

Under normal operating conditions (i.e., no optical transceiver failures), the optical signals from the n primary optical transceivers 104A, 104B are forwarded directly to the n inputs of the optical wavelength multiplexer 108A, 108B via the protection optics 106A, 106B, and the n signals from the optical wavelength demultiplexer 110A, 110B are forwarded to the n primary optical transceivers 104 A, 104B. In the transmit direction each of the primary optical transceivers 104A, 104B generates an optical wavelength having a unique frequency, and the optical wavelength multiplexer 108 A, 108B then multiplexes the n wavelengths into a single wavelength division multiplexed (WDM) signal that is then forwarded to an optical amplifier (AMP) (e.g., optical AMP 112A, 112B) to be transmitted over an inter-site optical fiber (e.g., inter-site optical fiber 114A, 114B). In the receive direction, the optical wavelength demultiplexer 110 A, 110B receives a WDM signal containing n wavelengths, and demultiplexes the n wavelengths onto n individual fibers, and the protection optics 106 A, 106B forwards the n wavelengths to the primary optical transceivers 104 A, 104B.

When a primary optical transceiver 104A, 104B fails, the protection optics 106A, 106B are used to substitute a redundant optical transceiver 105A, 105B (and the wavelength generated by it) for the failed primary optical transceiver 104A, 104B (and the wavelength generated by it), and the optical wavelength multiplexer 108A, 108B uses the wavelength generated by the redundant optical transceiver 105A, 105B in place of the wavelength generated by the failed primary optical transceiver 104A, 104B. Similarly, in the receive direction, the protection optics 106A, 106B are used to direct the demultiplexed wavelength previously forwarded to the failed primary optical transceiver 105A, 105B to the redundant optical transceiver 105A, 105B. In some example embodiments, an optical apparatus 102A, 102B may include attenuators 118A, 118B coupled to the primary optical transceivers 104A, 104B and configured to attenuate signals output from the primary optical transceivers 104A, 104B, for example, to reduce or eliminate insertion loss variance, as discussed in Table 1 below.

The protection optics 106A, 106B can be implemented with various technology, and with various optical protection schemes. One way of implementing the combination of protection optics and optical wavelength multiplexing is to use a wavelength selective switch (WSS) to perform both the wavelength multiplexing and the protection switching. A WSS used for this purpose would require a total of n+m inputs and a single output, wherein the n primary optical transceivers and m redundant optical transceivers would be attached to the inputs of the WSS. For this case, the wavelength associated with any failed primary optical transceiver 104A, 104B could be replaced by a wavelength from one of the redundant optical transceivers 105A, 105B by simply reprograming the WSS. Similarly, in the receive direction, both the demultiplexing function and the protection function could be implemented with a WSS having a single input and n+m outputs. Optical protection schemes using WSSs can be utilized in embodiments of the present disclosure, but may have higher cost, large physical packages, and high insertion loss as compared to other protection schemes disclosed herein.

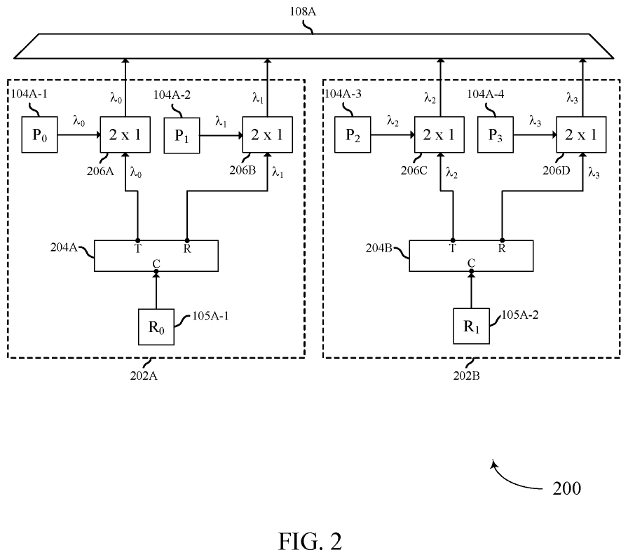

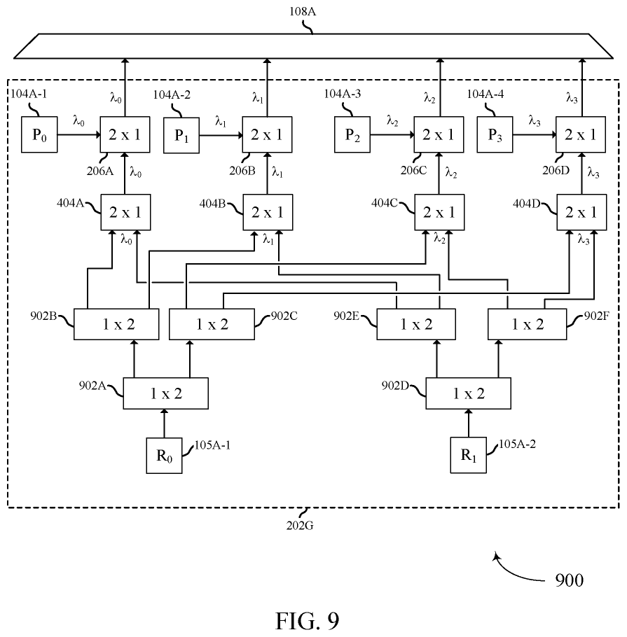

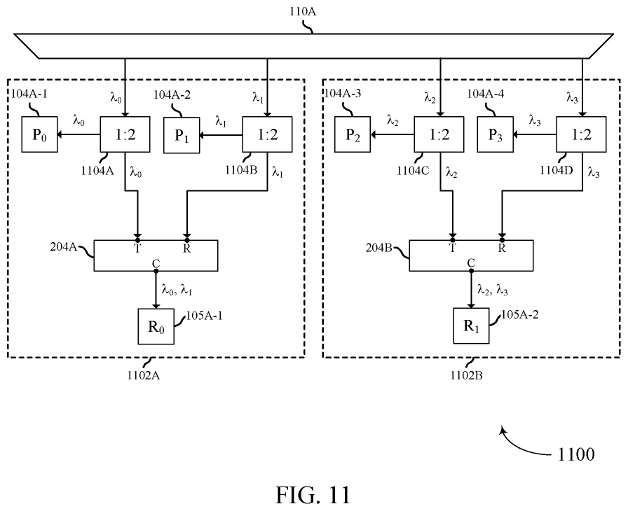

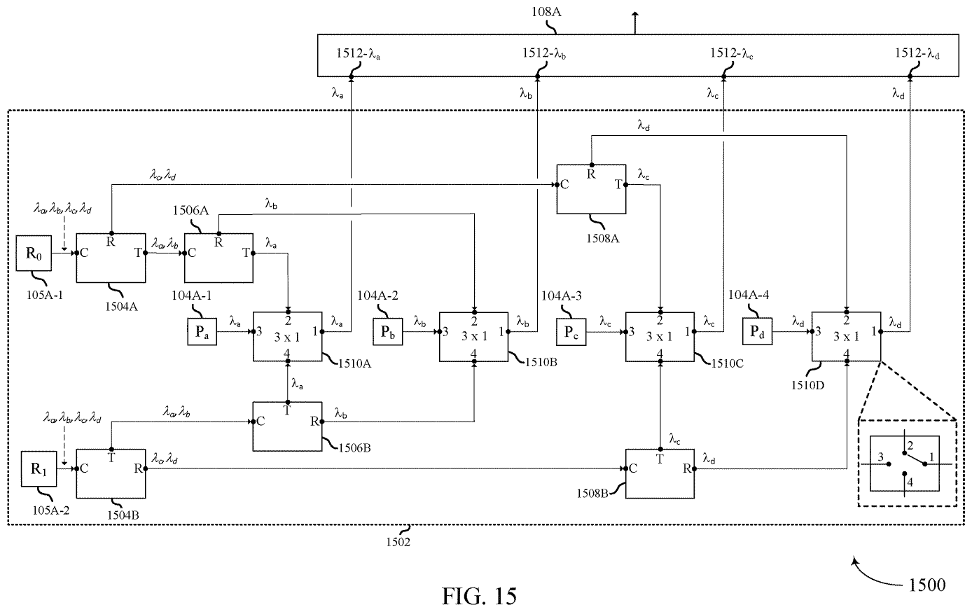

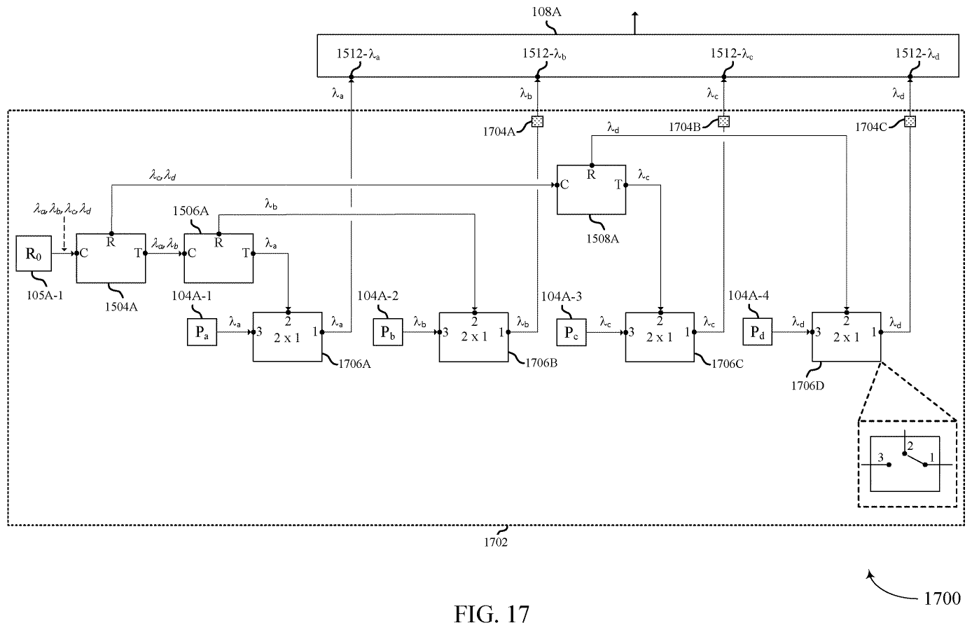

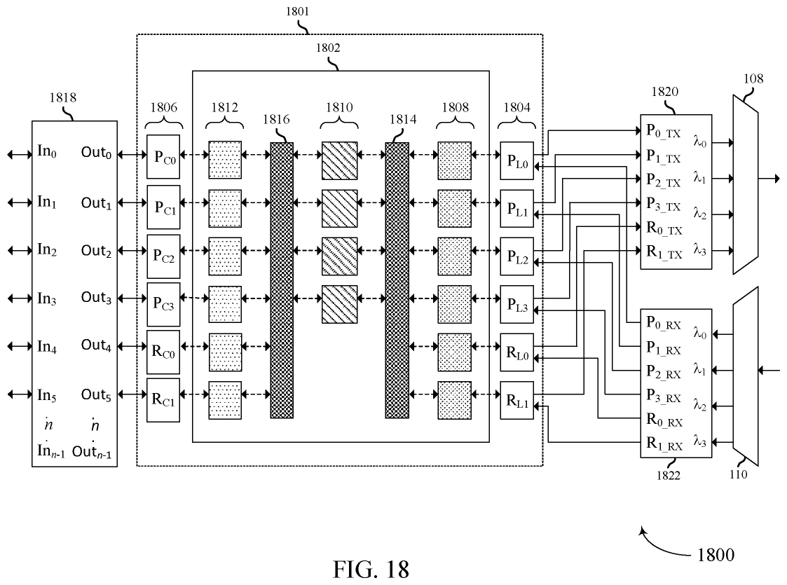

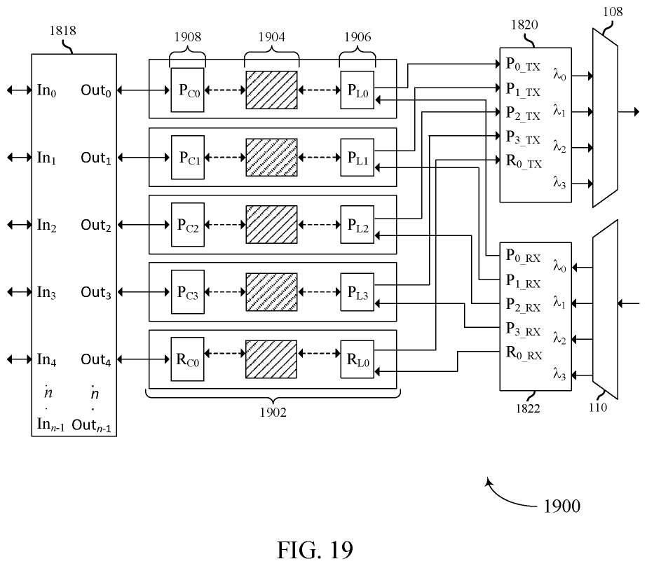

The protection schemes disclosed herein in to FIG. 9, FIG. 15, and FIG. 17 depict the protection in the transmit (multiplex (mux)) direction. Similarly, FIG. 11 to FIG. 14 and FIG. 16 depict the protection in the receive (demultiplex (dmux)) direction. For simplicity, FIGS. 2-9, 11-14, and 15-17 are described below with respect to the multiplexer 108A, the demultiplexer 110A, the primary transceivers 104A-1 to 104A-n, and the redundant transceivers 105A-1 to 105A-m. One of ordinary skill in the art can readily understand the embodiments of FIGS. 2-9, 11-14, and 15-17 be utilized with the multiplexer 108B, the demultiplexer 110B, the primary transceivers 104B-1 to 104B-n, and the redundant transceivers 105B-1 to 105B-m These protection schemes address the optical transceiver portion of the protection scheme. Additional electrical circuitry (not shown) would be required to reroute the electrical signals associated with the optical transceivers. FIG. 18 depicts the protection schemes integrated with co-packaged line and client optics. FIG. 19 depicts the protection schemes integrated with pluggable optics.

depicts a portion of an optical transmission system 200 showing protection optics for use with the multiplexer 108A in accordance with some embodiments of the present disclosure. FIG. 2 depicts protection groups 202A, 202B that support a 1-for-2 optical transceiver protection scheme (e.g., one redundant optical transceiver for two primary optical transceivers) using a combination of an optical thin-film filter (TFF) 204 and 2×1 broadband optical switches 206. Each protection group 202A, 202B may include redundant wavelength enable components configured to selectively forward one of a primary wavelength from a primary optical transceiver 104A-1 to 104A-2, 104A-3 to 104A-4 and a redundant wavelength from a redundant optical transceiver 105A-1, 105A-2 to the multiplexer 108A. Each protection group 202A, 202B may include one or more redundant wavelength distribution components configured to distribute (e.g., transmit, route, forward) redundant wavelengths to corresponding redundant wavelength enable components.

In the example of FIG. 2, each protection group 202A, 202B includes two 2×1 optical switches 206A, 206B; 206C, 206D (e.g., redundant wavelength enable components) and one 3-port TFF 204A, 204B (e.g., redundant wavelength distribution component). Alternatively, 1×2 optical switches could be used in place of each TFF 204A, 204B in some embodiments. Each 3-port TFF may include a common port C, a transmission port T, and a reflective port R. The advantages of using a TFF 204A, 204B instead of a 1×2 optical switch include lower cost, lower electrical power (no power is needed for a TFF), and lower complexity (no software support and no electronics support is needed for a TFF). Using a TFF 204A, 204B may cause the wavelengths exiting the first port of the 3-port TFF 204A, 204B (e.g., the transmission port T) to incur different optical insertion losses than wavelengths exiting the second port of the 3-port TFF 204 (e.g., the reflective port R), which generally would not be incurred when using an optical switch. However, this insertion loss variance can be corrected for and effectively zeroed out (see Table 1).

Protection group 202A includes a 2×1 optical switch 206A and a 2×1 optical switch 206B. The 2×1 optical switches 206A, 206B each have an output port coupled to an optical wavelength multiplexer 108A. A first input port of the 2×1 optical switch 206A is coupled to a primary optical transceiver P₀ 104A-1, wherein the optical transceiver P₀ 104A-1 is used to generate a wavelength (λ₀). A first input port of the 2×1 optical switch 206B is coupled to a primary optical transceiver P₁ 104A-2, wherein the primary optical transceiver P₁ 104A-2 is used to generate a wavelength (λ₁). The second input ports of the 2×1 optical switches 206A, 206B are respectively coupled to the output ports of the 3-port TFF 204A. For example, the second input port of the optical switch 206A may be coupled to the transmission port T of the TFF 204A, and the second input port of the optical switch 206B may be coupled to the reflective port R of the TFF 204A. The input port of the 3-port TFF 204A (e.g., the common port C) is coupled to a redundant optical transceiver R₀ 105A-1 which can be programmed to generate either wavelength λ₀ or λ₁.

Protection group 202B includes a 2×1 optical switch 206C and a 2×1 optical switch 206D. The 2×1 optical switches 206C, 206D each have an output port coupled to the optical wavelength multiplexer 108A. A first input port of the 2×1 optical switch 206C is coupled to a primary optical transceiver P₂ 104A-3, wherein the optical transceiver is used to generate a wavelength (λ₂). A first input port of the 2×1 optical switch 206D is coupled to a primary optical transceiver P₃ 104A-4, wherein the optical transceiver P₃ is used to generate a wavelength (λ₃). The second input ports of the 2×1 optical switches 206C, 206D are respectively coupled to the output ports of the 3-port TFF 204B. For example, the second input port of the optical switch 206C may be coupled to the transmission port T of the TFF 204B, and the second input port of the optical switch 206D may be coupled to the reflective port R of the TFF 204B. The input port of the 3-port TFF 204B (e.g., the common port C) is coupled to a redundant optical transceiver R₁ 105A-2 which can be programmed to generate either wavelength λ₂ or λ₃.

The redundant optical transceiver R₀ 105A-1 may be programmed to generate either wavelength λ₀ (corresponding to primary optical transceiver P₀ 104A-1) or wavelength λ₁ (corresponding to primary optical transceiver P₁ 104A-2), depending upon which primary optical transceiver P₀ 104A-1 or P₁ 104A-2 fails. Similarly, redundant optical transceiver R₁ 105A-2 may be programmed to generate either wavelength λ₂ (corresponding to primary optical transceiver P₂ 104A-3) or wavelength λ₃ (corresponding to primary optical transceiver P₃ 104A-4), depending upon which primary optical transceiver P₂ 104A-3 or P₃ 104A-4 fails. Each TFF 204A, 204B of the protection groups 202A and 202B is used to distribute the two wavelengths generated by the redundant optical transceiver R₀ 105A or R₁ 105B, and the 2×1 broadband optical switches 206A, 206B, 206C, 206D are used to replace the wavelength of a failed primary optical transceiver 104A-1 to 104A-4 with the wavelength of the associated redundant optical transceiver 105A-1, 105A-2. Though described herein using optical switches, the 2×1 optical switches 206, 206B, 206C, 206D in each protection group may be replaced by 2-to-1 optical couplers in some embodiments (as shown in).

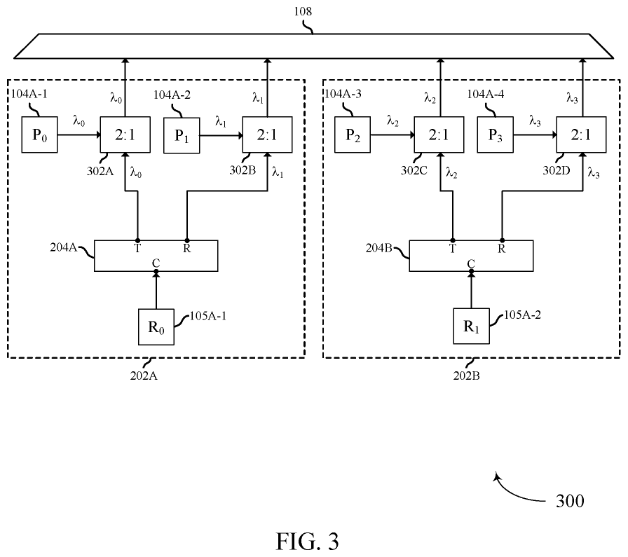

FIG. 3 depicts a portion of an optical transmission system 300 showing protection optics for use with a multiplexer in accordance with some embodiments of the present disclosure. In particular, FIG. 3 depicts the protection groups 202A, 202B using 2-to-1 (2:1) optical couplers 302A, 302B, 302C, 302D in place of the optical switches 206A, 206B, 206C, 206D, respectively. The optical couplers 302 may be examples of redundant wavelength enable components.

Using optical couplers 302A, 302B, 302C, 302D instead of optical switches 206 A, 206B, 206C, 206D produces a completely passive optical protection solution (i.e., a solution that requires no electrical power, as opposed to an active solution that requires electrical power). This results in an additional amount of optical insertion loss, as the insertion loss of the optical coupler is substantially greater than the insertion loss of the optical switch. However, this additional insertion loss may be mitigated by selection of the coupling ratio of the optical coupler. For example, a 2-to-1 optical coupler with a 60/40 coupling ratio with optical insertion losses of 2.5 dB at a second input port of the optical coupler (e.g., the input port coupled to the TFF 204A, 204B) and 4 dB at a first input port of the optical coupler (e.g., the input port coupled to the primary optical transceiver 104A-1 to 104A-4) could be utilized in the protection scheme of, resulting in an insertion loss of 4 dB for a wavelength generated by a primary optical transceiver 104 A-1 to 104A-4, and insertions losses of 3.5 dB and 2.9 dB for wavelengths generated by a redundant optical transceiver 105A-1, 105A-2 (assuming insertion losses of 1 dB through the transmission port T and 0.4 dB through the reflective port R of the TFF 204A, 204B). The 4 dB insertion loss for the primary optical transceiver is still worse (e.g., 2 dB worse) than when using an optical switch 206A, 206B, 206C, 206D (having 1 dB of insertion loss) instead of an optical coupler 302 A, 302B, 302C, 302D. Further, the optical insertion loss variance when using an optical coupler would be 0.1 dB worse, but similar to that of the optical switch implementation (e.g., a worst case insertion loss variance of 1.0 dB when using an optical switch 206 A, 206B, 206C, 206D compared to a worst case insertion loss variance of 1.1 dB when using an optical coupler 302 A, 302B, 302C, 302D).

In the protection schemes shown in and in FIG. 3, following a single primary optical transceiver 104A-1 to 104A-4 failure in a given protection group 202A, 202B, the remaining primary optical transceiver 104 A-1 to 104A-4 becomes unprotected. A second primary optical transceiver 104 A-1 to 104A-4 failure in each protection group 202A, 202B makes one wavelength unusable, thereby reducing the transmission capacity of the associated system by the transmission capacity of one optical transceiver. In some transmission systems, following the failure of an optical transceiver, the individual failed optical transceiver is modular and replaceable (perhaps front-panel replaceable), enabling protection to be restored by manually removing the failed optical transceiver and replacing it. However, in other transmission systems, failed optical transceivers may not be individually replaceable. For instance, all the optical transceivers could be embedded internally to a singular circuit card, or they could be embedded internal to a circuit chassis. In such systems, following some number of failures, a given amount of transmission capacity may be forever lost until the entire circuit card or circuit chassis is replaced.

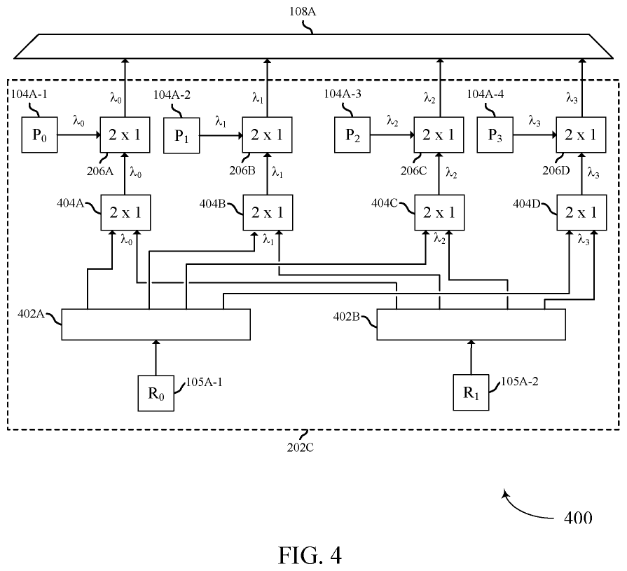

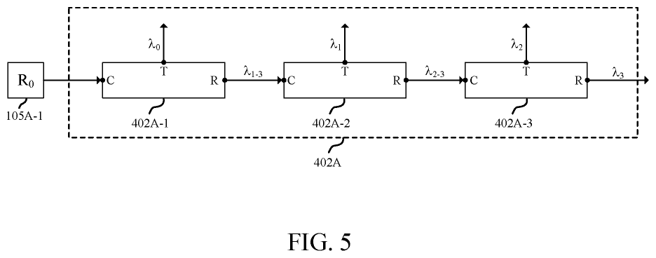

depicts a portion of an optical transmission system 400 showing protection optics for use with the multiplexer 108A in accordance with some embodiments of the present disclosure. Specifically, FIG. 4 depicts a protection group 202C that supports a 2-for-4 optical transceiver protection scheme using a combination of TFFs and 2×1 broadband optical switches. In FIG. 4, three 3-port TFFs (depicted in FIG. 4 as single units 402A, 402B, and shown in detail in FIG. 5 as including three 3-port TFF 402A-1, 402A-2, 402A-3) may be utilized in support of a given redundant optical transceiver (Rx) 105A-1, 105A-2. For example, a total of six 3-port TFFs 402 may be included in the protection group 202C.

The protection group 202C protects the same number of primary optical transceivers (e.g., 4) as in the embodiments of and FIG. 3, except in the single protection group 202C, if a single primary optical transceiver 104A-1 to 104A-4 fails, the remaining primary optical transceivers are all protected. This is because in the 2-for-4 protection scheme of FIG. 4, there are two redundant optical transceivers 105A-1, 105A-2 that are able to replace any of the four primary optical transceivers 104A-1 to 104A-4. In contrast, in the embodiments of FIG. 2, a primary optical transceiver 104A-1 to 104A-4 failure in a given protection group 202A, 202B would leave the remaining primary optical transceiver unprotected.

The protection group 202C includes first 2×1 optical switches (e.g., optical switches 206A, 206B, 206C, 206D) and second 2×1 optical switches (e.g., optical switches 404A, 404B, 404C, 404D). The first 2×1 optical switches 206A, 206B, 206C, 206D each have an output port coupled to a multiplexer 108A. First input ports of the first 2×1 optical switches 206A, 206B, 206C, 206D are respectively coupled to primary optical transceivers P₀ 104A-1, P₁ 104A-2, P₂ 104A-3, and P₃ 104A-4, where primary optical transceiver P₀ 104A-1, P₁ 104A-2, P₂ 104A-3, and P₃ 104A-4 respectively provide (e.g., generate, output) wavelengths λ₀, λ₁, λ₂, and λ₃. Second input ports of the first 2×1 optical switches 206A, 206B, 206C, 206D are each respectively coupled to the output ports of the second 2×1 optical switches 404A, 404B, 404C, 404D. Each input port of a given second 2×1 optical switch 404 is respectively coupled to redundant optical transceivers R₀ 105A-1 and R₁ 105A-2 via 3-port TFFs 402A, 402B as described with reference to FIG. 5. In some example embodiments, the first 2×1 optical switches 206A, 206B, 206C, 206D and/or second 2×1 optical switches 404A, 404B, 404C, 404D may be 2-to-1 optical couplers. The optical switches 404A, 404B, 404C, 404D (or optical couplers) may be referred to as redundant wavelength source selection components, where redundant wavelength source selection components may be configured to selectively forward a redundant wavelength from two or more redundant optical transceivers (e.g., redundant optical transceivers 105A-1, 105A-2) to a redundant wavelength enable components (e.g., first 2×1 optical switches 206A, 206B, 206C, 206D). The arrangement of TFF 402A for the redundant optical transceiver R₀ 105A-1 is depicted in greater detail in. One of ordinary skill in the art will recognize that the embodiments of FIG. 5 are applicable to TFF 402B and redundant optical transceiver R₁ 105A-2.

FIG. 5 depicts a TFF network in accordance with some embodiments of the present disclosure. The redundant optical transceiver R₀ 105A-1 is coupled to a first TFF 402A-1, where TFF 402A-1 is configured to pass (e.g., transmits, output) a through a transmission port T and reflect λ₁ to λ₃ through a reflective port R to a second TFF 402A-2. The second TFF 402A-2 is configured to pass λ₁ through a transmission port T and reflect λ₂ to λ₃ through a reflective port R to a third TFF 402A-3. The third TFF 402A-3 may be configured to pass λ₂ through a transmission port T and reflect λ₃ through a reflective port R. For example, if R₀ 105A-1 is configured to provide wavelength λ1, then TFF 402A-1 would reflect wavelength λ1 to TFF 402A-2. In the example of FIG. 4, first input ports of the second 2×1 optical switches 404A, 404B, 404C, 404D may be coupled, respectively, with the transmission port T of the first TFF 402A-1, the transmission port T of the second TFF 402A-2, the transmission port T of the third TFF 402A-3, and the reflective port R of the third TFF 402A-3, where the TFF 402A-1, 402A-2, 402A-3 are the TFFs 402A depicted as a single unit. In this embodiment, each of TFF 402A-1 to TFF 402A-3 is unique in that each is configured to pass and reflect certain wavelengths.

For the above protection scheme, either of the redundant optical transceivers (R₀ 105A-1, R₁ 105A-1) can replace any of the four primary optical transceivers (P₀ 104A-1, P₁ 104A-2, P₂ 104A-3, P₃ 104A-4), thus providing higher reliability when compared to the previous 1-for-2 protection scheme shown in FIGS. 2 and 3. For this scheme, following a single primary optical transceiver 104A-1 to 104A-4 failure, the remaining optical transceivers are still protected. In the scheme of, three primary optical transceiver failures in the protection group would be needed to reduce the transmission capacity by that of a single optical transceiver.

The additional reliability of the protection scheme depicted in requires additional costs, such as an additional four 2×1 optical switches (e.g., optical switches 404A, 404B, 404C, 404D) and an additional four 3-port TFFs 402A, 402B in comparison to the embodiments of FIG. 2. The worst-case insertion loss may increase to 3.8 dB. For example, assuming each TFF 402A-1, 402A-2, and 402A-3 has a 1 dB insertion loss through the transmission port T and 0.4 insertion loss through the reflective port R, the insertion loss of a wavelength exiting the transmission port T of TFF 402A-3 (e.g., λ₂) may be 1.8 dB (e.g., 0.4 dB through reflective port R of TFF 402AA-1, 0.4 dB through reflective port R of TFF 402-2, and 1 dB through). Each optical switch 404A, 404B, 404C, 404D and optical switch 206A, 206B, 206C, 206D may have an insertion loss of 1 dB, resulting in a 3.8 dB insertion loss. Here, the insertion loss variance may be as high as 2.8 dB (i.e., the difference between the insertion loss of the worst-case path through the protection network of a wavelength generated by a redundant optical transceiver 105—3.8 dB, and the insertion loss experienced by a wavelength generated by a primary optical transceiver 104—1 dB through an optical switch 206A, 206B, 206C, 206D).

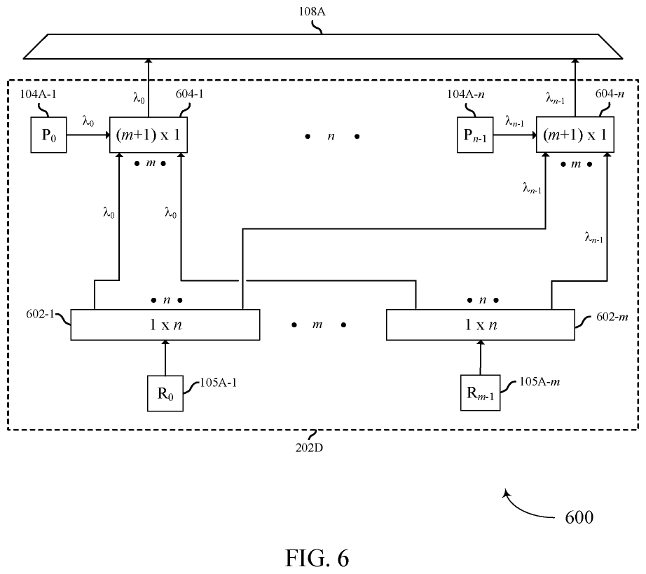

depicts a portion of an optical transmission system 600 showing protection optics for use with the multiplexer 108A in accordance with some embodiments of the present disclosure. FIG. 6 depicts a protection group 202D with the optical switches used to create any m-for-n protection scheme within a protection group 202D when using all broadband optical switches, where m corresponds to the number of redundant optical transceivers 105A-1 to 105A-m and n corresponds to the number of primary optical transceivers 104A-1 to 104A-n. In the protection group 202D, the TFFs used in the embodiments of FIGS. 2-5 have been replaced with broadband optical switches (e.g., 1×n optical switches 602-1 through 602-m, (m+1)×1 optical switches 604-1 through 604-n). Each of the (m+1)×1 switches 604-1 to 604-n depicted in FIG. 6 may be implemented using a single (m+1)×1 broadband optical switch (as shown). For example, the single (m+1)×1 broadband optical switch 604-1 to 604-n may be a micro electro-mechanical systems (MEMs) switch that supports two or more angles of reflection. Alternatively, each of the (m+1)×1 switches 604-1 through 604-n may be a plurality of 2×1 broadband optical switches (not shown in FIG. 6). Similarly, each of the 1×n optical switches 602-1 through 602-m may be implemented using a single 1×n broadband optical switch (as shown in FIG. 6). For example, the single 1×n broadband optical switch 602-1 to 602-m may be a MEMs switch that supports two or more angles of reflection. Alternatively, each of the 1×n optical switches 602-1 through 602-m may be a plurality of 1×2 broadband optical switches (not shown in FIG. 6). Values of m may range from 1 to any integer number greater than 1. Values of n may range from 1 to any integer number greater than 1. For larger values of n and/or m, such as 2 or more, it may be beneficial to implement the switching arrays using silicon photonics. For n primary optical transceivers there are m redundant optical transceivers, where n is generally greater than m, but this does not always need to be true.

Each (m+1)×1 broadband optical switch 604-1 to 604-n receives an input signal from one of n primary optical transceivers P₀ 104A-1 to Pₙ₋₁ 104A-n. Further, each (m+1)×1 broadband optical switch is configured to receive m input signals from m redundant optical transceivers R₀ 105A-1 to Rₘ₋₁ 105A-m via the m 1×n broadband optical switches 602-1 to 602-m. Each (m+1)×1 broadband optical switch 604-1 to 604-n outputs a signal to the multiplexer 108A. Each 1×n broadband optical switch 602-1 to 602-m receives an input signal from one of the m redundant optical transceivers R₀ 105A-1 to Rₘ₋₁ 105A-m. Each 1×n broadband optical switch 602-1 to 602-m may output n wavelengths λ₀ to λₙ₋₁ to each of the (m+1)×1 broadband optical switches 604-1 to 604-n. In an alternative embodiment, each 1×n optical switch 602-1 to 602-m may be replaced by n−1 3-port TFFs without any loss of functionality (not shown in).

The 1×n optical switches 602-1 to 602-m may be examples of redundant wavelength distribution components. The (m+1)×1 broadband optical switches 604-1 to 604-n may be redundant wavelength enable components and redundant wavelength source selection components as they are configured to both selectively forward a primary or redundant wavelength to the multiplexer 108A and select from which redundant optical transceiver 105A-1 to 105A-m the redundant wavelength is forwarded.

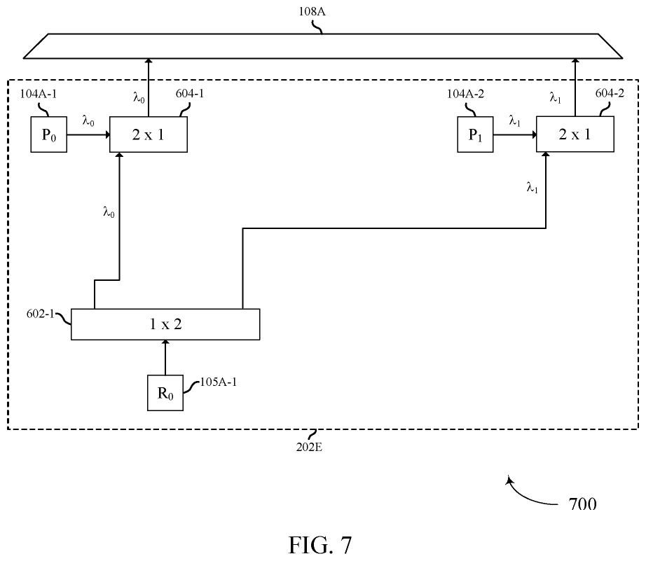

depicts a portion of an optical transmission system 700 showing protection optics for use with the multiplexer 108A in accordance with some embodiments of the present disclosure. Whereas FIG. 6 depicts a generalized protection group 202D having n number of primary optical transceivers and m number of protection optical transceivers, FIG. 7 depicts a protection group 202E where n=2 and m=1 (e.g., including one 1×2 optical switch 602-1, two 2×1 optical switches 604-1, 604-2, and one redundant optical transceiver R₀ 105A-1).

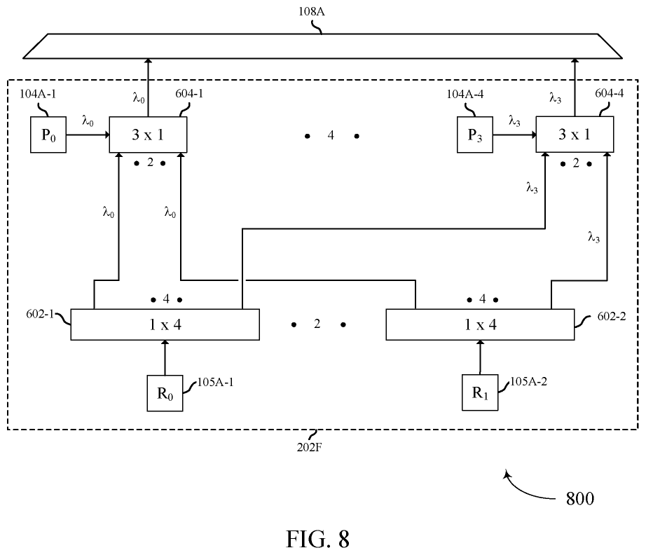

depicts a portion of an optical transmission system 800 showing protection optics for use with the multiplexer 108A in accordance with some embodiments of the present disclosure. FIG. 8 depicts a protection group 202F where n=4 and m=2 (e.g., including two 1×4 optical switches 602-1, 602-2, four 3×1 optical switches 604-1 to 604-4, and two redundant optical transceivers R₀ 105A, R₁ 105-2). The protection group 202F is a 2-for-4 protection group like that depicted in FIG. 4, except that the protection group depicted in FIG. 8 uses single 3×1 broadband optical switches 604-1 to 604-4 instead of dual 2×1 broadband optical switches 206A to 206D, 404A to 404D to perform the redundant wavelength source selection function and the redundant wavelength enable function (in accordance with the FIG. 6 embodiment), and uses single 1×4 broadband optical switches 602-1, 602-2 instead of TFFs 402A, 402B to perform the redundant wavelength distribution function (in accordance with the FIG. 6 embodiment).

depicts a portion of an optical transmission system 900 showing protection optics for use with the multiplexer 108A in accordance with some embodiments of the present disclosure. FIG. 9 depicts a protection group 202G that supports the same 2-for-4 protection scheme of FIG. 8 except the embodiment of FIG. 9 uses only 2×1 and 1×2 broadband optical switches. For example, the protection group 202G may include the 2×1 optical switches 206A, 206B, 206C, 206D and the 2×1 optical switches 404A, 404B, 404C, 404D of FIG. 4. Instead of the TFFs 402A, 402B, the protection group 202G may include two sets of three 1×2 optical switches-optical switches 902A, 902B, 902C coupled to redundant optical transceiver R₀ 105A-1, and optical switches 902D, 902E, 902F coupled to redundant optical transceiver R₁ 105A-2. The input of the optical switch 902A may be coupled to the redundant optical transceiver R₀ 105A-1, and each of the two outputs of the optical switch 902A may be respectively coupled to an input of the optical switches 902B, 902C. Each of the outputs of the optical switches 902B, 902C may be respectively coupled to an input of one of the optical switches 404A, 404B, 404C, 404D, as depicted. The optical switches 902D, 902E, 902F may be similarly arranged, as depicted in FIG. 9.

The protection scheme of provides the same 2-for-4 protection scheme as that of FIG. 4, but it is more complex than that of FIG. 4, due to the six additional active components (i.e., optical switches 902A to 902F). The embodiments of FIG. 9 may be implemented in a photonic integrated circuit (PIC). However, the insertion losses associated with a PIC may result in an overall implementation with higher optical insertion losses.

displays a summary of the protection schemes of some of the embodiments disclosed herein. Protection scheme 3 is the only choice for a completely passive solution, as all other solutions use broadband optical switches, which are active components that use electrical power in order to switch states. Protection scheme 2 has the lowest optical insertion loss (IL) and uses the least number of active components for protection schemes having active components. However, for protection scheme 2, as discussed herein, the level of protection is more limited if a single primary optical transceiver fails. For the more robust protection schemes of 4 and 5, protection scheme 4 has insertion loss and insertion loss variance that is no worse than protection scheme 3 and also has fewer active components than protection scheme 5.

TABLE 1

| | | 2 × 1/ | 3 | | Max | Max IL | | | |
|---|---|---|---|---|---|---|---|---|---|
| | | 1 × 2 | port | Optical | IL | variance | | Active/ | |
| Scheme | Description | switches | TFFs | couplers | (dB) | (dB) | FIG. | Passive | Comments |
| 1 | 1-for-2 | 6 | 0 | 0 | 2 | 1 or 0* | 7 | Active | *IL variance |
| | protection | | | | | | | | can be |
| | with all | | | | | | | | reduced to 0 |
| | optical | | | | | | | | dB by adding |
| | switches | | | | | | | | 1 dB |
| | | | | | | | | | attenuators |
| | | | | | | | | | to the signals |
| | | | | | | | | | from Pₓ or |
| | | | | | | | | | attenuating |
| | | | | | | | | | the Pₓ output |
| | | | | | | | | | power |
| | | | | | | | | | internal to the |
| | | | | | | | | | transceiver |
| 2 | 1-for-2 | 4 | 2 | 0 | 2 | 1 or 0.6 | 2 | Active | *IL variance |
| | protection | | | | | or 0* | | | can be |
| | with | | | | | | | | reduced to |
| | optical | | | | | | | | 0.6 dB by |
| | switches | | | | | | | | adding 1 dB |
| | and TFF | | | | | | | | attenuators |
| | | | | | | | | | to signals |
| | | | | | | | | | from Pₓ or |
| | | | | | | | | | attenuating |
| | | | | | | | | | the Pₓ output |
| | | | | | | | | | power. IL |
| | | | | | | | | | variance can |
| | | | | | | | | | further be |
| | | | | | | | | | reduced to 0 |
| | | | | | | | | | dB by also |
| | | | | | | | | | adding a 0.6 |
| | | | | | | | | | dB attenuator |
| | | | | | | | | | to the |
| | | | | | | | | | reflective |
| | | | | | | | | | output of the |
| | | | | | | | | | TFF. |
| 3 | 1-for-2 | 0 | 2 | 4 | 4* | 1.1 or | 3, where | Passive | *Assuming |
| | protection | | | | | 0.6 or | optical | | 60/40 coupler |
| | with | | | | | 0** | switches | | and assumes |
| | optical | | | | | | are | | failed |
| | couplers | | | | | | replaced | | transceiver's |
| | and TFF | | | | | | with | | laser can be |
| | | | | | | | optical | | turned off. |
| | | | | | | | couplers | | **IL |
| | | | | | | | | | Variance can |
| | | | | | | | | | be reduced to |
| | | | | | | | | | 0.6 dB by |
| | | | | | | | | | adding 0.5 |
| | | | | | | | | | dB |
| | | | | | | | | | attenuators to |
| | | | | | | | | | the signals |
| | | | | | | | | | from Rₓ or |
| | | | | | | | | | attenuating |
| | | | | | | | | | the Rₓ output |
| | | | | | | | | | power |
| | | | | | | | | | internal to the |
| | | | | | | | | | transceiver. |
| | | | | | | | | | IL variance |
| | | | | | | | | | can further be |
| | | | | | | | | | reduced to 0 |
| | | | | | | | | | dB by also |
| | | | | | | | | | adding a 0.6 |
| | | | | | | | | | dB attenuator |
| | | | | | | | | | to the |
| | | | | | | | | | reflective |
| | | | | | | | | | output of the |
| | | | | | | | | | TFF. |
| 4 | 2-for-4 | 8 | 6 | 0 | 3.8 | 2.8 or | 4 | Active | **IL |
| | protection | | | | | 0.8 or | | | Variance can |
| | with | | | | | 0* | | | be reduced to |
| | optical | | | | | | | | 0.8 dB by |
| | switches | | | | | | | | adding 2.8 |
| | and TFFs | | | | | | | | dB |
| | | | | | | | | | attenuators to |
| | | | | | | | | | the signals |
| | | | | | | | | | from Pₓ or |
| | | | | | | | | | attenuating |
| | | | | | | | | | the Pₓ output |
| | | | | | | | | | power |
| | | | | | | | | | internal to the |
| | | | | | | | | | transceiver. |
| | | | | | | | | | IL variance |
| | | | | | | | | | can further be |
| | | | | | | | | | reduced to 0 |
| | | | | | | | | | dB by also |
| | | | | | | | | | adding a 0.8 |
| | | | | | | | | | dB attenuator |
| | | | | | | | | | to the |
| | | | | | | | | | transmission |
| | | | | | | | | | out TFF₁, a |
| | | | | | | | | | 0.4 dB |
| | | | | | | | | | attenuator to |
| | | | | | | | | | the |
| | | | | | | | | | transmission |
| | | | | | | | | | output of |
| | | | | | | | | | TFF₂, and a |
| | | | | | | | | | 0.6 dB |
| | | | | | | | | | attenuator to |
| | | | | | | | | | the reflective |
| | | | | | | | | | output of |
| | | | | | | | | | TFF₃. |
| 5 | 2-for-4 | 14 | 0 | 0 | 4 | 3 or 0* | 9 | Active | **IL |
| | Protection | | | | | | | | Variance can |
| | using all | | | | | | | | be reduced to |
| | optical | | | | | | | | 0 dB by |
| | switches | | | | | | | | adding 3 dB |
| | | | | | | | | | attenuators to |
| | | | | | | | | | the signals |
| | | | | | | | | | from Pₓ or |
| | | | | | | | | | attenuating |
| | | | | | | | | | the Pₓ output |
| | | | | | | | | | power |
| | | | | | | | | | internal to the |
| | | | | | | | | | transceiver. |

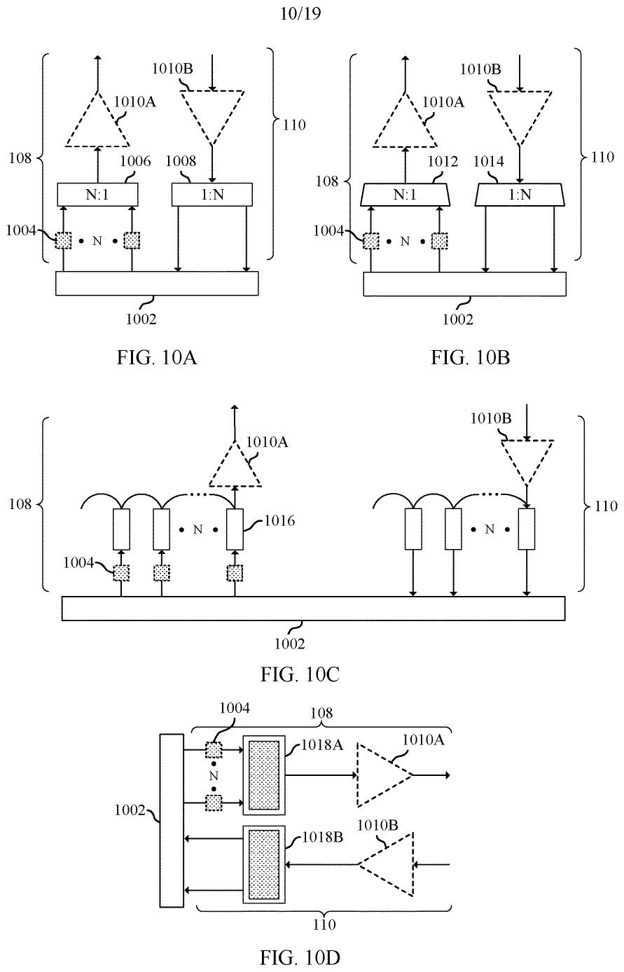

FIGS. 10A, 10B, 10C, and 10D depict various embodiments of multiplexers and demultiplexers in accordance with some embodiments of the present disclosure. The multiplexers and demultiplexers may be utilized with the embodiments disclosed herein. As such, any of the multiplexers and demultiplexers depicted in can be implemented with any of the four types of multiplexers and demultiplexers depicted in FIGS. 10A-D, among other types of multiplexers and demultiplexers.

FIG. 10A depicts an optical multiplexer 108 and demultiplexer 110, where the multiplexer 108 comprises an N:1 optical coupler 1006 and optionally an amplifier 1010A, and the demultiplexer 110 comprises an optical coupler 1008 and optionally an amplifier 1010B. The multiplexer 108 may further comprise optional photodiodes 1004 between the optical couplers 1006, 1008 and optical transceivers 1002 (e.g., N optical transceivers).

FIG. 10B depicts an optical multiplexer 108 and demultiplexer 110, where the multiplexer 108 comprises an N:1 arrayed waveguide grating (AWG) 1012 and optionally an amplifier 1010A, and the demultiplexer 110 comprises an AWG 1014 and optionally the amplifier 1010B. The multiplexer 108 may further comprise the optional photodiodes 1004 between the arrayed waveguide gratings 1012, 1014 and the optical transceivers 1002.

FIG. 10C depicts an optical multiplexer 108 and demultiplexer 110, where each comprises a plurality of TFFs 1016 and optionally the amplifier 1010A, 1010B. The multiplexer 108 may further comprise the optional photodiodes 1004 between the plurality of TFFs 1016 of the multiplexer 108 and the optical transceivers 1002.

FIG. 10D depicts an optical multiplexer 108 and demultiplexer 110, where each includes a WSS 1018A, 1018B and optionally the amplifier 1010A, 1010B. The multiplexer 108 may further comprise the optional photodiodes 1004 between the WSS 1018A and the optical transceivers 1002.

FIG. 11 depicts a portion of an optical transmission system 1100 showing protection optics for use with the demultiplexer 110A in accordance with some embodiments of the present disclosure. FIG. 11 depicts protection groups 1102A, 1102B that support a 1-for-2 optical transceiver protection scheme. The structure is identical to the structure depicted in, except it is used in the reverse direction for the demultiplexing protection optics. Each protection group 1102A, 1102B uses two 1-to-2 (1:2) optical couplers 1104A, 1104B; 1104C, 1104D, and one 3-port TFF 204A, 204B. For example, the protection group 1102A may include optical coupler 1104A coupled to primary optical transceiver 104A-1 and TFF 204A and optical coupler 1104B coupled to primary optical transceiver 104A-2 and TFF 204A. The protection group 1102B may include optical coupler 1104C coupled to primary optical transceiver 104A-3 and TFF 204B and optical coupler 1104D coupled to primary optical transceiver 104A-4 and TFF 204B. In normal operation, the receiver portion of a given redundant optical transceiver 105A-1, 105A-2 may receive two wavelengths. Here, the receiver is a coherent receiver, capable of discriminating between multiple wavelengths, so that it is able to select the desired wavelength. In some example embodiments, the TFFs 204A, 204B may be replaced with 2-to-1 optical couplers, without any loss of functionality.

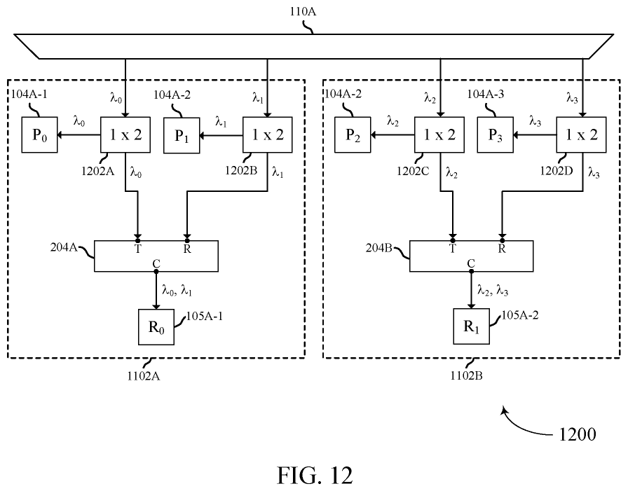

FIG. 12 depicts a portion of an optical transmission system 1200 showing protection optics for use with the demultiplexer 110A in accordance with some embodiments of the present disclosure. The structure is identical to the structure depicted in, except it is used in the reverse direction for the demultiplexing protection optics. Each protection group uses two 1-by-2 (1×2) broadband optical switches 1202A, 1202B; 1202C, 1202D, and one 3-port TFF 204A, 204B. For example, the protection group 1102A may include optical switch 1202A coupled to primary optical transceiver 104A-1 and TFF 204A and optical switch 1202B coupled to primary optical transceiver 104A-2 and TFF 204A. The protection group 1102B may include optical switch 1202C coupled to primary optical transceiver 104A-3 and TFF 204B and optical switch 1202D coupled to primary optical transceiver 104A-4 and TFF 204B. For this case, the receiver may or may not be a coherent receiver, as it receives one wavelength.

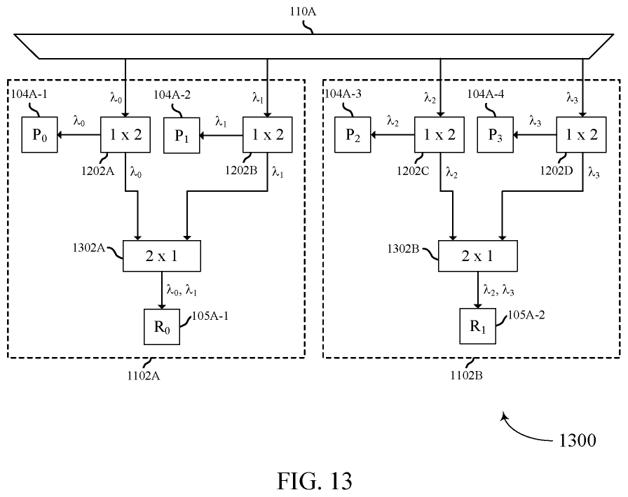

FIG. 13 depicts a portion of an optical transmission system 1300 showing protection optics for use with the demultiplexer 110A in accordance with some embodiments of the present disclosure. Each protection group uses two 1-by-2 (1×2) broadband optical switches 1202 A, 1202B; 1202C, 1202D, and one 2-by-1 (2×1) broadband optical switch 1302A, 1302B. The embodiment of FIG. 13 is similar to that of FIG. 12, except the TFFs 204A, 204B of FIG. 12 are replaced by 2×1 broadband optical switches 1302A, 1302B.

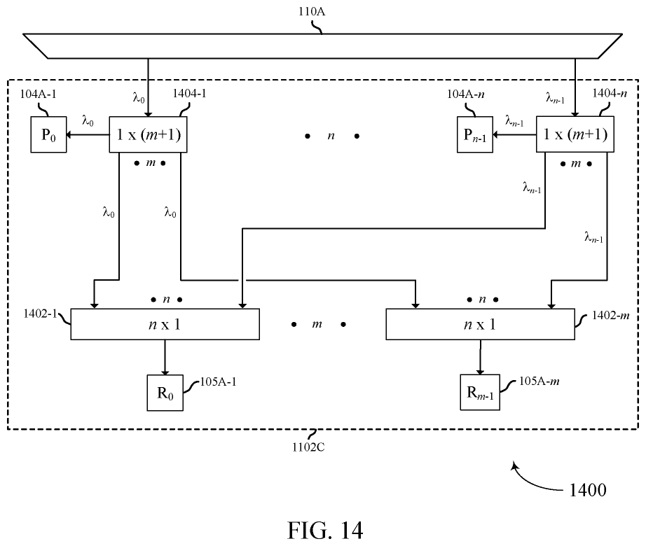

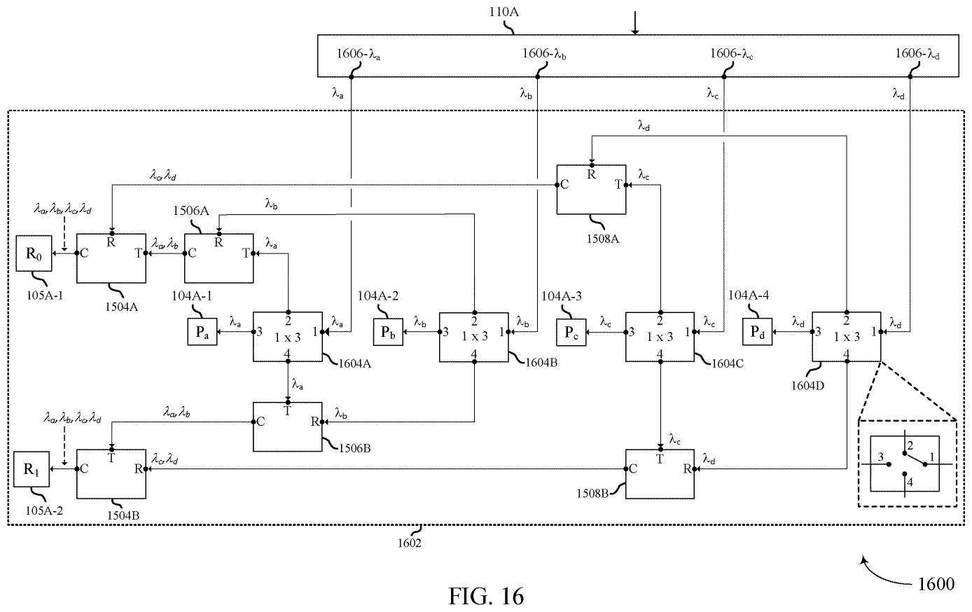

FIG. 14 depicts a portion of an optical transmission system 1400 showing protection optics for use with the demultiplexer 110A in accordance with some embodiments of the present disclosure. FIG. 16 depicts a protection group 1102C with the optical switches used to create any m-for-n protection scheme within a protection group 1102C when using all broadband optical switches. The protection optics shown in FIG. 14 are identical to those shown in, except optical signals operate in the reverse direction. In the protection group 1102C, the TFFs 204A, 204B used in the embodiment of FIG. 12 have been replaced with broadband optical switches 1402-1 to 1402-m. For example, the protection group 1102C may include m n×1 optical switches 1402A to 1402-m. In an alternative embodiment, each n×1 optical switch may be replaced by n−1 3-port TFFs without any loss of functionality. The TFFs may be strung together like those depicted in FIG. 5. In the protection group 1102C, the 1×2 optical switches 1202A to 1202D may be replaced with 1×(m+1) optical switches 1404-1 to 1404-n. For example, the protection group 1102C may include n 1×(m+1) optical switches 1404A to 1402-n.

FIG. 15 depicts a portion of an optical transmission system 1500 showing protection optics for use with the multiplexer 108A in accordance with some embodiments of the present disclosure. The optical transmission system 1500 includes a protection group 1502 coupled to the multiplexer 108A. The protection group 1502 is a 2-for-4 protection group coupled to a portion of a multi-port multiplexer. The protection group is substantially similar to the protection group of FIG. 4, except four (3×1) broadband optical switches 1510A, 1510B, 1510C, 1510D are used in place of the eight (2×1) broadband optical switches in FIG. 4, and the TFFs are cascaded differently than as shown in FIG. 5. Also, the TFFs are designed differently than those in FIG. 5. For example, the protection group 1502 may include three types of TFFs, TFFs 1504A, 1504B referred to as type 0, TFFs 1506A, 1506B referred to as type 1, and TFFs 1508A, 1508B referred to as type 2. Type 0 TFF 1504A, 1504B may be configured to transmit (pass) wavelengths λₐ, λ_{b} and reflect wavelengths λ_{c}, λ_{d}. Type 1 TFF 1506A, 1506B may be configured to transmit wavelength λₐ and reflect wavelengths λ_{b}. Type 2 TFF 1508A, 1508B may be configured to transmit wavelength λ_{c} and reflect wavelengths λ_{d}.

In the example of FIG. 15, the redundant optical transceivers 105A-1, 105A-2 may be configured to generate any of wavelengths λₐ, λ_{b}, λ_{c}, λ_{d}. The redundant optical transceivers 105A-1, 105A-2 may be respectively coupled to common ports C of TFFs 1504A, 1504B. The transmission ports T of the TFFs 1504A, 1504B may be respectively coupled to the common ports C of TFFs 1506A, 1506B. The reflective ports R of the TFFs 1504A, 1504B may be respectively coupled to the common ports C of TFFs 1508A, 1508B.

The optical switches 1510A, 1510B, 1510C, 1510D may be respectively coupled to primary optical transceivers Pₐ 104A-1, P_{b} 104A-2, P_{c} 104A-3, P_{d} 104A-4 via an input port (e.g., port 3). Optical switch 1510A may be coupled to the transmission port T of the TFF 1506A via an input port (e.g., port 2) and the transmission port T of the TFF 1506B via an input port (e.g., port 4). Optical switch 1510B may be coupled to the reflective port R of the TFF 1506A via an input port (e.g., port 2) and the reflective port R of the TFF 1506B via an input port (e.g., port 4). Optical switch 1510C may be coupled to the transmission port T of the TFF 1508A via an input port (e.g., port 2) and the transmission port T of the TFF 1508B via an input port (e.g., port 4). Optical switch 1510D may be coupled to the reflective port R of the TFF 1508A via an input port (e.g., port 2) and the reflective port R of the TFF 1508B via an input port (e.g., port 4). Each of the optical switches 1510A, 1510B, 1510C, 1510D may be respectively coupled to an input port 1512-λₐ, 1512-λ_{b}, 1512-λ_{c}, 1512-λ_{d} of the multiplexer 108A via an output port (e.g., port 1). The optical switches 1510A, 1510B, 1510C, 1510D may be configured to selectively forward a primary wavelength or a redundant wavelength to the corresponding input port 1512 of the multiplexer 108A.

In some example embodiments, such as when the protection group 1502 is coupled to a portion of a 16-port multiplexer, the wavelengths of the primary optical transceivers 104A-1 to 104A-4 may not be consecutive, like they are in FIG. 4. For example, the 16-port multiplexer may be configured to multiplex wavelengths 0 through 15. Primary optical transceiver Pₐ 104A-1 may be P₀ configured to transmit wavelength 0 (i.e., λ₀), primary optical transceiver P_{b} 104A-2 may be P₄ configured to transmit wavelength 4 (i.e., λ₄), primary optical transceiver P_{c} 104A-3 may be P₈ configured to transmit wavelength 8 (i.e., λ₈), and primary optical transceiver P_{d} 104A-4 may be P₁₂ configured to transmit wavelength 12 (i.e., λ₁₂).

Here, Type 0 TFF 1504A, 1504B may be configured to transmit wavelengths 0, 1, 4, and 5, and reflect wavelengths 8, 9, 12, and 13. Type 1 TFF 1506A, 1506B may be configured to transmits wavelengths 0 and 1 and reflect wavelengths 4 and 5. Type 2 TFF 1508A, 1508B may be configured to transmits wavelengths 8 and 9 and reflect wavelengths 12 and 13. Therefore, within each TFF there are two skipped wavelengths separating the transmit (pass) and reflect groups of wavelengths (wavelengths 6 and 7 in Type 0, wavelengths 2 and 3 in Type 1, and wavelengths 10 and 11 in Type 2). By skipping two wavelengths between the transmitted and reflected wavelengths, the filter edge between the two sets of wavelengths can be designed such that its slope is much more gradual, and therefore, the insertion loss of the filter is lower than for the TFF where there are no skipped wavelengths between the transmit and reflect wavelengths. In some example embodiments, such as when the protection group 1502 is coupled to a portion of a 4-port multiplexer, the wavelengths of the primary optical transceivers 104A-1 to 104A-4 may be consecutive. For example, wavelengths λₐ, λ_{b}, λ_{c}, λ_{d} may be wavelengths λ₀, λ₁, λ₂, λ₃.

FIG. 16 depicts a portion of an optical transmission system 1600 showing protection optics for use with the demultiplexer 110A in accordance with some embodiments of the present disclosure. The optical transmission system 1600 includes a protection group 1602 coupled to the demultiplexer 110A. The protection group 1602 may be a 2-for-4 protection group coupled to a portion of a multi-port demultiplexer. The receive protection group structure depicted in FIG. 16 is substantially identical to the structure of the transmit protection group shown in FIG. 15, except that the optical signal flow is in the reverse direction, and (1×3) broadband optical switches 1604A, 1604B, 1604C, 1604D are used in place of (3×1) broadband optical switches 1510A, 1510B, 1510C, 1510D. The TFFs 1504A, 1504B, 1506A, 1506B, 1508A, 1508B are identical to those used in the FIG. 15 structure. The optical switches 1604A, 1604B, 1604C, 1604D may be configured to receive wavelengths λₐ, λ_{b}, λ_{c}, λ_{d}, respectively, from output ports 1606-λₐ, 1606-λ_{b}, 1606-λₑ, 1606-λ_{d} of the demultiplexer 110A. One additional advantage of spacing the wavelengths within a protection group by four (e.g., wavelengths 0, 4, 8, and 12 in the 16-port multiplexer embodiment of protection group 1502), is that if all four wavelengths are present at a given redundant coherent receiver (R_{i_RX}) then it is easier for the coherent receiver to discriminate between the four wavelengths. It should be noted that the same exact TFFs 1504A, 1504B, 1506A, 1506B, 1508A, 1508B used in protection group 1502 may be used in protection group 1602 if protection group 1602 protects wavelengths 1, 5, 9, and 13. That is, the TFFs of the protection group 1502 and protection group 1602 may be shared by (e.g., common to) the protection groups 1502, 1602.

FIG. 17 depicts a portion of an optical transmission system 1700 showing protection optics for use with the multiplexer 108A in accordance with some embodiments of the present disclosure. The optical transmission system 1700 includes a protection group 1702 coupled to the multiplexer 108A. The protection group 1702 may be a 1-for-4 protection group coupled to a portion of a multi-port demultiplexer (e.g., a 4-port multiplexer). The transmit protection group structure depicted in FIG. 17 is substantially similar to the structure of the transmit protection group shown in FIG. 15, except that the redundant optical transceiver R₁ 105A-2 and the TFFs 1504B, 1506B, 1508B are removed and (2×1) broadband optical switches 1706A, 1706B, 1706C, 1706D are accordingly used in place of the (3×1) broadband optical switches 1510A, 1510B, 1510C, 1510D. TFFs 1504A, 1506A, 1508A are used and coupled to the optical switches 1706A, 1706B, 1706C, 1706D in the same manner as they are coupled to the optical switches 1510A, 1510B, 1510C, 1510D. In some example embodiments, the protection group 1702 may include one or more attenuators 1704A, 1704B, 1704C coupled to one or more of the multiplexer input ports (e.g., attenuator 1704A coupled to input port 1512-λ_{b}, attenuator 1704B coupled to input port 1512-λ_{c}, and attenuator 1704C coupled to input port 1512-λ_{d}) and configured to attenuate wavelength signals entering the corresponding multiplexer input ports.

Like the protection group 1602 relative to the protection group 1502, the protection group 1702 may be modified for use with a demultiplexer, for example, by using (1×2) broadband optical switches in place of the (2×1) broadband optical switches 1706A, 1706B, 1706C, 1706D.

FIG. 18 depicts an optical transmission system 1800 in accordance with some embodiments of the present disclosure. In the example of FIG. 18, solid lines between components represent the communication of optical signals, and dotted lines between components represent the communication of electrical signals. The optical transmission system 1800 depicts protection optics described herein integrated with a co-packaged optics architecture. For example, the optical transmission system 1800 may include protection optics 1820 for use with a multiplexer 108 and protection optics 1822 for use with a demultiplexer 110. The protection optics 1820, 1822 may be coupled to co-packaged optics 1801. The co-packaged optics 1801 may be a single circuit card that includes an application-specific integrated circuit (ASIC) 1802, co-packaged line optics 1804 and co-packaged client optics 1806. The ASIC 1802 may be a common ASIC to the co-packaged line optics 1804 and co-packaged client optics 1806.

The co-packaged line optics 1804 may include optical transceivers. In the example of FIG. 18, the protection scheme may support a 2-for-4 protection scheme as described herein. For example, the co-packaged line optics 1804 may include four primary optical transceivers P_{L0} through P_{L3} and two redundant optical transceivers R_{L0}, R_{L1}. The co-packaged client optics 1806 may include optical transceivers. In the example of FIG. 18, co-packaged client optics 1806 may include four primary optical transceivers P_{C0} through P_{C3} and two redundant optical transceivers R_{C0}, R_{C1}. The co-packaged line optics 1804 and the co-packaged client optics 1806 may be embedded within the co-packaged optics 1801 and may not be individually replaceable.

The ASIC 1802 may include line-side processing circuitry 1808 configured to drive the co-packaged line optics 1804 and client-side processing circuitry 1812 configured to drive the co-packaged client optics 1806. The ASIC 1802 may include client-line-side processing circuitry 1810 configured to drive the co-packaged line optics 1804 and the co-packaged client optics 1806.

The protection optics 1820 may be transmit protection optics coupled between the co-packaged line optics 1804 and the multiplexer 108. The protection optics 1822 may be receive protection optics coupled between the co-packaged line optics 1804 and the demultiplexer 110.

The ASIC 1802 may include a line switch 1814 configured to route a line-side signal associated with a failed primary optical transceiver P_{L} to one of the redundant optical transceivers R_{L}. For example, based on (in response to) the primary optical transceiver P_{L1} failing, the line switch 1814 may be configured to route a line-side signal associated with the primary optical transceiver P_{L1} (e.g., associated with driving the primary optical transceiver P_{L1}) to the redundant optical transceiver R_{L0} (e.g., to drive the redundant optical transceiver R_{L0}). In some examples, the line-side processing circuitry 1808 may be configured to detect whether an optical transceiver of the co-packaged line optics 1804 has failed.

The ASIC 1802 may include a client switch 1816 configured to route a client-side signal associated with a failed primary client optics path (e.g., associated with a primary optical transceiver P_{C}) to a redundant client optics path (e.g., associated with redundant optical transceiver R_{C}). For example, based on (in response to) the primary optical transceiver P_{C1} failing, the client switch 1816 may be configured to route a client-side signal associated with the primary optical transceiver P_{C1} (e.g., associated with driving the primary optical transceiver P_{C1}) to the redundant optical transceiver R_{C0} (e.g., to drive the redundant optical transceiver R_{C0}). In some other examples, failure of a primary client optics path may include failure of a link driving the primary client optics path (e.g., client processing circuitry driving the path).

The optical transmission system 1800 may include an optical circuit switch 1818 coupled to the co-packaged client optics 1806. The optical circuit switch 1818 may be configured to route optical signals from the co-packaged client optics 1806 between various input ports Iₙ₀ through Inₙ₋₁ and output ports Out₀ through Outₙ₋₁.

FIG. 19 depicts an optical transmission system in accordance with some embodiments of the present disclosure. In the example of FIG. 19, solid lines between components represent the communication of optical signals, and dotted lines between components represent the communication of electrical signals. The optical transmission system 1900 depicts protection optics described herein integrated with a pluggable architecture. For example, the optical transmission system 1900 may include protection optics 1820 for use with a multiplexer 108 and protection optics 1822 for use with a demultiplexer 110. The protection optics 1820, 1822 may be coupled to transponders 1902. The transponders 1902 may be configured to communicate (e.g., receive, generate) client-side signals via a client-side interface (e.g., via client-side optical transceivers 1908) and communicate (e.g., receive, generate) line-side optical signals via a line-side interface (e.g., via line-side optical transceivers 1906).

Each transponder 1902 may include an ASIC 1904 configured to process signals between the client-side optical transceivers 1908 and line-side optical transceivers 1906. The line-side optical transceivers 1906 may include one or more primary optical transceivers P_{L} (e.g., P_{L0} through P_{L3}) and one or more redundant optical transceivers R_{L} (e.g., R_{L0}). The line-side optical transceivers 1906 may be coupled to the protection optics 1820, 1822. The client-side optical transceivers 1908 may include one or more primary optical transceivers P_{C} (e.g., P_{C0} through P_{C3}) and one or more redundant optical transceivers R_{C} (e.g., R_{C0}). The client-side optical transceivers 1908 may be coupled to an optical circuit switch 1818. The line-side optical transceivers 1906 may be front panel pluggable to a circuit card that includes the protection optics 1820, 1822 and the multiplexer 108, demultiplexer 110.

The following provides an overview of aspects of the present disclosure:

Aspect 1. An optical apparatus, comprising: a multiplexer; a plurality of primary optical transceivers coupled to the multiplexer and configured to generate a plurality of primary wavelengths; one or more redundant optical transceivers coupled to the multiplexer and configured to generate a plurality of replacement wavelengths; and first protection optics, the first protection optics configured to replace a primary wavelength from a primary optical transceiver in the plurality with a replacement wavelength from the one or more redundant optical transceivers when the primary optical transceiver fails.

Aspect 2. The optical apparatus of aspect 1, wherein the first protection optics are configured to replace primary wavelengths of two of the primary optical transceivers with corresponding replacement wavelengths from one of the one or more redundant optical transceivers.

Aspect 3. The optical apparatus of aspect 1, wherein the one or more redundant optical transceivers comprises two redundant optical transceivers, and wherein the first protection optics are configured to replace the primary wavelengths of four of the primary optical transceivers with corresponding replacement wavelengths from the two redundant optical transceivers.

Aspect 4. The optical apparatus of any of aspects 1 through 3, further comprising: a wavelength demultiplexer configured to output a plurality of wavelengths; and second protection optics, wherein the plurality of primary optical transceivers and the one or more reductant optical transceivers are coupled to the wavelength demultiplexer via the second protection optics, and wherein the second protection optics are configured to: forward the plurality of wavelengths to the plurality of primary optical transceivers; and forward a wavelength from the wavelength demultiplexer to one of the one or more redundant optical transceivers instead of one of the plurality of primary optical transceivers when the one of the plurality of primary optical transceivers fails.

Aspect 5. The optical apparatus of any of aspects 1 through 4, wherein the first protection optics comprise at least one thin-film filter, and at least two selected, independently, from the group consisting of an optical switch and an optical coupler.

Aspect 6. The optical apparatus of aspect 5, wherein the at least one thin-film filter is configured to distribute the replacement wavelength from the one or more redundant optical transceivers.

Aspect 7. The optical apparatus of any of aspects 1 through 6, wherein the first protection optics comprise: a set of thin-film filters; and a set of three-input, one-output optical components each coupled to a respective primary optical transceiver, a respective port of the wavelength multiplexer, and two of the thin-film filters, wherein each of the three-input, one-output optical components is independently selected from the group consisting of a 3×1 optical switch and a 3:1 optical coupler.

Aspect 8. The optical apparatus of any of aspects 1, 4 through 6, wherein: the plurality of primary optical transceivers comprises n primary optical transceivers, the one or more redundant optical transceivers comprise m redundant optical transceivers, and the first protection optics comprise m (1×n) optical switches coupled to the m redundant optical transceivers.

Aspect 9. The optical apparatus of any of aspects 1, 4 through 6, and 8, wherein: the plurality of primary optical transceivers comprises n primary optical transceivers, the one or more redundant optical transceivers comprise m redundant optical transceivers, and the first protection optics comprise n ((m+1)×1) optical switches coupled to the n primary optical transceivers.

Aspect 10. The optical apparatus of any of aspects 1, 4 through 6, and 9, wherein: the plurality of primary optical transceivers comprises n primary optical transceivers, the one or more redundant optical transceivers comprise m redundant optical transceivers, and the first protection optics comprise m sets of thin-film filters coupled to the m redundant optical transceivers, each set of thin-film filters comprising (n−1) thin-film filters.

Aspect 11. The optical apparatus of any of aspects 1, 4 through 6, and 9, wherein: the plurality of primary optical transceivers comprises n primary optical transceivers, the one or more redundant optical transceivers comprise m redundant optical transceivers, and the first protection optics comprise (n−1) one-input, two-output optical components, each one-input, two-output optical component independently selected from the group consisting of a 1×2 optical switch and a 1:2 optical coupler.

Aspect 12. The optical apparatus of any of aspects 1, 4 through 6, 8, and 10, wherein: the plurality of primary optical transceivers comprises n primary optical transceivers, the one or more redundant optical transceivers comprise m redundant optical transceivers, and the first protection optics comprise (n*m) two-input, one-output optical components, each one-input, two-output optical component independently selected from the group consisting of a 2×1 optical switch and a 2:1 optical coupler.

Aspect 13. The optical apparatus of any of aspects 1 through 12, further comprising: a second plurality of primary optical transceivers operable to communicate with a server; one or more other redundant optical transceivers operable to communicate with a server; and an integrated circuit coupled to the plurality of primary optical transceivers and the one or more redundant optical transceivers via a first interface and to the second plurality of primary optical transceivers and the one or more other redundant optical transceiver via a second interface, wherein the integrated circuit is configured to process signals communicated between the first interface and the second interface.

Aspect 14. An optical apparatus, comprising: a wavelength demultiplexer configured to output a plurality of wavelengths; a plurality of primary optical transceivers coupled to the wavelength demultiplexer; one or more redundant optical transceivers coupled to the wavelength demultiplexer; and first protection optics, wherein the plurality of primary optical transceivers and the one or more reductant optical transceivers are coupled to the wavelength demultiplexer via the first protection optics, and wherein the first protection optics are configured to: forward the plurality of wavelengths to the plurality of primary optical transceivers; and forward a wavelength from the wavelength demultiplexer to one of the one or more redundant optical transceivers instead of one of the plurality of primary optical transceivers when the one of the plurality of primary optical transceivers fails.

Aspect 15. The optical apparatus of aspect 14, further comprising: a wavelength multiplexer coupled to the plurality of primary optical transceivers and to the one or more redundant optical transceivers, wherein the plurality of primary optical transceivers are configured to generate a plurality of primary wavelengths, and wherein the one or more redundant optical transceivers are configured to generate a plurality of replacement wavelengths; and second protection optics, wherein the plurality of primary optical transceivers and the one or more reductant optical transceivers are coupled to the wavelength multiplexer via the second protection optics, and wherein the second protection optics are configured to replace a primary wavelength from a primary optical transceiver in the plurality with a replacement wavelength from the one or more redundant optical transceivers when the primary optical transceiver fails.

Aspect 16. The optical apparatus of any of aspects 14 through 15, wherein the first protection optics comprise at least one thin-film filter, and at least two selected, independently, from the group consisting of an optical switch and an optical coupler.

Aspect 17. The optical apparatus of any of aspects 14 through 16, wherein the first protection optics comprise: a set of thin-film filters; and a set of one-input, three-output optical components each coupled to a respective primary optical transceiver, a respective port of the demultiplexer, and two of the thin-film filters, wherein each of the one-input, three-output optical components is independently selected from the group consisting of a 1×3 optical switch and a 1:3 optical coupler.

Aspect 18. The optical apparatus of any aspects 14 through 16, wherein: the plurality of primary optical transceivers comprises n primary optical transceivers, the one or more redundant optical transceivers comprise m redundant optical transceivers, and the first protection optics comprise m (n×1) optical switches coupled to the m redundant optical transceivers.

Aspect 19. The optical apparatus of any aspects 14 through 16 and 18, wherein: the plurality of primary optical transceivers comprises n primary optical transceivers, the one or more redundant optical transceivers comprise m redundant optical transceivers, and the first protection optics comprise n (1×(m+1)) optical switches coupled to the n primary optical transceivers.

Aspect 20. The optical apparatus of any aspects 14 through 16, and 19, wherein: the plurality of primary optical transceivers comprises n primary optical transceivers, the one or more redundant optical transceivers comprise m redundant optical transceivers, and the first protection optics comprise m sets of thin-film filters coupled to the m redundant optical transceivers, each set of thin-film filters comprising (n−1) thin-film filters.

Aspect 21. The optical apparatus of any of aspects 14 through 16, 18, and 20, wherein: the plurality of primary optical transceivers comprises n primary optical transceivers, the one or more redundant optical transceivers comprise m redundant optical transceivers, and the first protection optics comprise (n−1) two-input, one-output optical components, each two-input, one-output optical component independently selected from the group consisting of a 2×1 optical switch and a 2:1 optical coupler.

Aspect 22. The optical apparatus of any of aspects 14 through 16, 19, and 21, wherein: the plurality of primary optical transceivers comprises n primary optical transceivers, the one or more redundant optical transceivers comprise m redundant optical transceivers, and the first protection optics comprise (n*m) one-input, two-output optical components, each one-input, two-output optical component selected from the group consisting of a 1×2 optical switch and a 1:2 optical coupler.

Aspect 23. The optical apparatus of any of aspects 14 through 22, further comprising: a second plurality of primary optical transceivers operable to communicate with a server; one or more other redundant optical transceivers operable to communicate with a server; and an integrated circuit coupled to the plurality of primary optical transceivers and the first redundant optical transceiver via a first interface and to the second plurality of primary optical transceivers and the one or more other redundant optical transceivers via a second interface, wherein the integrated circuit is configured to process signals communicated between the first interface and the second interface.

Aspect 24. A method for optical communications at an optical apparatus comprising a multiplexer, a plurality of primary optical transceivers, one or more redundant optical transceivers, and first protection optics, the method comprising: generating a plurality of primary wavelengths using the plurality of primary optical transceivers for output to the multiplexer; detecting that a primary optical transceiver of the plurality of primary optical transceivers failed; replacing, using the first protection optics and based on the detecting, a primary wavelength associated with the failed primary optical transceiver with a replacement wavelength from the one or more redundant optical transceivers; and outputting the replacement wavelength to the multiplexer.

Aspect 25. The method of aspect 24, wherein the optical apparatus further comprises a demultiplexer and second protection optics, the method further comprising: outputting, from the demultiplexer, a plurality of wavelengths; and forwarding, using the second protection optics, a wavelength from the demultiplexer to one of the one or more redundant optical transceivers instead of the first primary optical transceiver based on the detecting.

Aspect 26. An optical apparatus, comprising: a wavelength multiplexer configured to multiplex a plurality of wavelengths; a protection group comprising four primary optical transceivers and two redundant optical transceivers; and protection optics configured to couple the four primary optical transceivers and the two redundant optical transceivers to the wavelength multiplexer, wherein the protection optics comprise a plurality of cascaded thin-film filters and a plurality of optical switches, wherein at least one thin-film filter of the plurality of cascaded thin-film filters is configured to transmit a first group of wavelengths from the plurality and reflect a second group of wavelengths from the plurality, and wherein the first group of wavelengths and the second group of wavelengths are separated in wavelength by at least one skipped wavelength from the plurality that is excluded from the first group of wavelengths and from the second group of wavelengths.

Aspect 27. The optical apparatus of aspect 26, wherein the plurality of optical switches are configured to selectively couple one of the two redundant optical transceivers to an optical path corresponding to a failed one of the four primary optical transceivers.

Aspect 28. The optical apparatus of any of aspects 26 through 27, wherein the first group of wavelengths and the second group of wavelengths are separated by two wavelengths from the plurality.

Aspect 29. The optical apparatus of aspect 28, wherein the plurality of wavelengths comprise sixteen wavelengths 0 through 15, wherein a first thin-film filter of the plurality of cascaded thin-film filters is configured to transmit wavelengths 0, 1, 4, and 5 and reflect wavelengths 8, 9, 12, and 13, wherein a second thin-film filter of the plurality of cascaded thin-film filters is configured to transmit wavelengths 0 and 1 and reflect wavelengths 4 and 5, and wherein a third thin-film filter of the plurality of cascaded thin-film filters is configured to transmit wavelengths 8 and 9 and reflect wavelengths 12 and 13.

Aspect 30. The optical apparatus of aspect 29, wherein the two skipped wavelengths separating the transmitted and reflected wavelength groups of the first thin-film filter are wavelengths 6 and 7, the two skipped wavelengths separating the transmitted and reflected wavelength groups of the second thin-film filter are wavelengths 2 and 3, and the two skipped wavelengths separating the transmitted and reflected wavelength groups of the third thin-film filter are wavelengths 10 and 11.

Aspect 31. The optical apparatus of any of aspects 26 through 30, wherein either of the two redundant optical transceivers is configured to replace any of the four primary optical transceivers.

Aspect 32. An optical apparatus, comprising: a wavelength multiplexer; and at least one optical protection group coupled to the wavelength multiplexer, the at least one optical protection group comprising: at least two primary optical transceivers configured to generate primary wavelengths for output to the wavelength multiplexer, at least one redundant optical transceiver configured to generate replacement wavelengths, and protection optics configured to substitute, based on a failure of one of the at least two primary optical transceivers, a replacement wavelength for a primary wavelength configured to be output by the failed primary optical transceiver, wherein the protection optics comprise: at least two redundant wavelength enable components associated with the at least two primary optical transceivers; and at least one thin-film filter configured to receive the replacement wavelength from the at least one redundant optical transceiver and distribute the replacement wavelength to a redundant wavelength enable component of the at least two redundant wavelength enable components that is associated with the failed primary optical transceiver, wherein the redundant wavelength enable component is configured to selectively forward one of the primary wavelength and the replacement wavelength to the wavelength multiplexer.

Aspect 33. The optical apparatus of aspect 32, wherein the redundant wavelength enable component comprises optical switches.

Aspect 34. The optical apparatus of any of aspects 33 through 34, wherein the at least one protection group further comprises at least two attenuators coupled with the at least two primary optical receivers and configured to attenuate the primary wavelengths generated by the at least two primary optical receivers based on an insertion loss associated with substituting the replacement wavelengths for the primary wavelengths.

Aspect 35. The optical apparatus of any of aspects 32 through 34, wherein the failed primary optical transceiver is configured to have its laser turned off during substitution of the replacement wavelength.

Aspect 36. The optical apparatus of any of aspects 32 through 35, wherein the at least one optical protection group comprises two primary optical transceivers configured to generate two primary wavelengths and one redundant optical transceiver configured to generate the two primary wavelengths corresponding to the two primary optical transceivers, and wherein the at least one thin-film filter is configured to distribute the two primary wavelengths generated by the redundant optical transceiver to the redundant wavelength enable components associated with the two primary optical transceivers.

Aspect 37. The optical apparatus of aspect 36, wherein following the failure of primary optical transceiver, the other of the two primary optical transceivers remains operational but unprotected.

Aspect 38. The optical apparatus of any of aspects 32 through 37, wherein the at least two primary optical transceivers and the at least one redundant optical transceiver comprise co-packaged line optics coupled to a common ASIC, wherein the at least two primary optical transceivers and the at least one redundant optical transceiver are embedded within a single circuit card and are not individually replaceable.

Aspect 39. The optical apparatus of aspect 38, wherein the common ASIC comprises line-side processing circuitry configured to drive the co-packaged line optics.

Aspect 40. The optical apparatus of aspect 39, further comprising: a wavelength demultiplexer and second protection optics, wherein the protection optics comprise transmit protection optics coupled between the co-packaged line optics and the wavelength multiplexer, and wherein the second protection optics comprise receive protection optics coupled between the wavelength demultiplexer and the co-packaged line optics.

Aspect 41. The optical apparatus of any of aspects 39 through 40, wherein the common ASIC further comprises a line switch configured, responsive to failure of one of the at least two primary optical transceivers, to route a line-side signal associated with the failed primary optical transceiver to the at least one redundant optical transceiver.

Aspect 42. The optical apparatus of aspect 41, wherein the common ASIC further comprises a client switch configured, responsive to failure of a primary client optics path, to route a client-side signal to a redundant client optics path.

Aspect 43. The optical apparatus of aspect 42, wherein a failure of the primary client optics path comprises one of failure of a primary client optics device and failure of a link driving the primary client optics path.

Aspect 44. The optical apparatus of any of aspects 32 through 37, wherein each of the at least two primary optical transceivers and the at least one redundant optical transceiver comprises a transponder configured to receive client-side signals via a client-side interface and generate a line-side optical signal for the wavelength multiplexer.

Aspect 45. The optical apparatus of aspect 44, wherein the at least two primary optical transceivers and the at least one redundant optical transceiver are front panel pluggable to a circuit card comprising the wavelength multiplexer and the at least one optical protection group.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the term “and/or” used herein is intended to signify and include any or all possible combinations of one or more items listed in the associated list.

It shall be understood that although the terms “first,” “second,” “third,” etc. may be used herein to describe various information, the information should not be limited by these terms. These terms are only used to distinguish one category of information from another. For example, without departing from the scope of the present disclosure, the first information may be termed as second information, and similarly, the second information may also be termed as first information.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and second condition or action may at least partially occur as a result of the previous condition or action occurring (whether directly after or after one or more other intermediate conditions or actions occurring after the first condition or action).

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “comprising” and any form of comprising, such as “comprise” and “comprises,” “having” and any form of having, such as “has” and “have,” “including” and any form of including, such as “includes” and “include,” or “containing” and any form of containing, such as “contains” and “contain,” are inclusive and open-ended and do not exclude additional, unrecited elements or method steps.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

What is claimed is:

1. An optical apparatus, comprising:
a wavelength multiplexer;
a plurality of primary optical transceivers coupled to the wavelength multiplexer and configured to generate a plurality of primary wavelengths;
one or more redundant optical transceivers coupled to the wavelength multiplexer and configured to generate a plurality of replacement wavelengths; and
first protection optics,
wherein the plurality of primary optical transceivers and the one or more reductant optical transceivers are coupled to the wavelength multiplexer via the first protection optics, and
wherein the first protection optics are configured to replace a primary wavelength from a primary optical transceiver in the plurality with a replacement wavelength from the one or more redundant optical transceivers when the primary optical transceiver fails.

2. The optical apparatus of claim 1, wherein the first protection optics are configured to replace primary wavelengths of two of the primary optical transceivers with corresponding replacement wavelengths from one of the one or more redundant optical transceivers.

3. The optical apparatus of claim 1, wherein the one or more redundant optical transceivers comprises two redundant optical transceivers, and wherein the first protection optics are configured to replace the primary wavelengths of four of the primary optical transceivers with corresponding replacement wavelengths from the two redundant optical transceivers.

4. The optical apparatus of claim 1, further comprising:
a wavelength demultiplexer configured to output a plurality of wavelengths; and
second protection optics,
wherein the plurality of primary optical transceivers and the one or more reductant optical transceivers are coupled to the wavelength demultiplexer via the second protection optics, and
wherein the second protection optics are configured to:
forward the plurality of wavelengths to the plurality of primary optical transceivers; and
forward a wavelength from the wavelength demultiplexer to one of the one or more redundant optical transceivers instead of one of the plurality of primary optical transceivers when the one of the plurality of primary optical transceivers fails.

5. The optical apparatus of claim 1, wherein the first protection optics comprise at least one thin-film filter, and at least two selected, independently, from the group consisting of an optical switch and an optical coupler.

6. The optical apparatus of claim 5, wherein the at least one thin-film filter is configured to distribute the replacement wavelength from the one or more redundant optical transceivers.

7. The optical apparatus of claim 1, wherein the first protection optics comprise:
a set of thin-film filters; and
a set of three-input, one-output optical components each coupled to a respective primary optical transceiver, a respective port of the wavelength multiplexer, and two of the thin-film filters, wherein each of the three-input, one-output optical components is independently selected from the group consisting of a 3×1 optical switch and a 3:1 optical coupler.

8. The optical apparatus of claim 1, wherein:
the plurality of primary optical transceivers comprises n primary optical transceivers,
the one or more redundant optical transceivers comprise m redundant optical transceivers, and
the first protection optics comprise m (1×n) optical switches coupled to the m redundant optical transceivers.

9. The optical apparatus of claim 1, wherein:
the plurality of primary optical transceivers comprises n primary optical transceivers,
the one or more redundant optical transceivers comprise m redundant optical transceivers, and
the first protection optics comprise n ((m+1)×1) optical switches coupled to the n primary optical transceivers.

10. The optical apparatus of claim 1, wherein:
the plurality of primary optical transceivers comprises n primary optical transceivers,
the one or more redundant optical transceivers comprise m redundant optical transceivers, and
the first protection optics comprise m sets of thin-film filters coupled to the m redundant optical transceivers, each set of thin-film filters comprising (n−1) thin-film filters.

11. The optical apparatus of claim 1, further comprising:
a second plurality of primary optical transceivers operable to communicate with a server;
one or more other redundant optical transceivers operable to communicate with a server; and
an integrated circuit coupled to the plurality of primary optical transceivers and the one or more redundant optical transceivers via a first interface and to the second plurality of primary optical transceivers and the one or more other redundant optical transceiver via a second interface,
wherein the integrated circuit is configured to process signals communicated between the first interface and the second interface.

12. An optical apparatus, comprising:
a wavelength demultiplexer configured to output a plurality of wavelengths;
a plurality of primary optical transceivers coupled to the wavelength demultiplexer;
one or more redundant optical transceivers coupled to the wavelength demultiplexer; and
first protection optics,
wherein the plurality of primary optical transceivers and the one or more reductant optical transceivers are coupled to the wavelength demultiplexer via the first protection optics, and
wherein the first protection optics are configured to:
forward the plurality of wavelengths to the plurality of primary optical transceivers; and
forward a wavelength from the wavelength demultiplexer to one of the one or more redundant optical transceivers instead of one of the plurality of primary optical transceivers when the one of the plurality of primary optical transceivers fails.

13. The optical apparatus of claim 12, further comprising:
a wavelength multiplexer coupled to the plurality of primary optical transceivers and to the one or more redundant optical transceivers, wherein the plurality of primary optical transceivers are configured to generate a plurality of primary wavelengths, and wherein the one or more redundant optical transceivers are configured to generate a plurality of replacement wavelengths; and
second protection optics, wherein the plurality of primary optical transceivers and the one or more reductant optical transceivers are coupled to the wavelength multiplexer via the second protection optics, and
wherein the second protection optics are configured to replace a primary wavelength from a primary optical transceiver in the plurality with a replacement wavelength from the one or more redundant optical transceivers when the primary optical transceiver fails.

14. The optical apparatus of claim 12, wherein the first protection optics comprise at least one thin-film filter, and at least two selected, independently, from the group consisting of an optical switch and an optical coupler.

15. The optical apparatus of claim 12, wherein the first protection optics comprise:
a set of thin-film filters; and
a set of one-input, three-output optical components each coupled to a respective primary optical transceiver, a respective port of the demultiplexer, and two of the thin-film filters, wherein each of the one-input, three-output optical components is independently selected from the group consisting of a 1×3 optical switch and a 1:3 optical coupler.

16. The optical apparatus of claim 12, wherein:
the plurality of primary optical transceivers comprises n primary optical transceivers,
the one or more redundant optical transceivers comprise m redundant optical transceivers, and
the first protection optics comprise (n−1) two-input, one-output optical components, each two-input, one-output optical component independently selected from the group consisting of a 2×1 optical switch and a 2:1 optical coupler.

17. The optical apparatus of claim 12, wherein:
the plurality of primary optical transceivers comprises n primary optical transceivers,
the one or more redundant optical transceivers comprise m redundant optical transceivers, and
the first protection optics comprise (n*m) one-input, two-output optical components, each one-input, two-output optical component selected from the group consisting of a 1×2 optical switch and a 1:2 optical coupler.

18. The optical apparatus of claim 12, further comprising:
a second plurality of primary optical transceivers operable to communicate with a server;
one or more other redundant optical transceivers operable to communicate with a server; and
an integrated circuit coupled to the plurality of primary optical transceivers and the first redundant optical transceiver via a first interface and to the second plurality of primary optical transceivers and the one or more other redundant optical transceivers via a second interface,
wherein the integrated circuit is configured to process signals communicated between the first interface and the second interface.

19. A method for optical communications at an optical apparatus comprising a multiplexer, a plurality of primary optical transceivers, one or more redundant optical transceivers, and first protection optics, the method comprising:
generating a plurality of primary wavelengths using the plurality of primary optical transceivers for output to the multiplexer;
detecting that a primary optical transceiver of the plurality of primary optical transceivers failed;
replacing, using the first protection optics and based on the detecting, a primary wavelength associated with the failed primary optical transceiver with a replacement wavelength from the one or more redundant optical transceivers; and
outputting the replacement wavelength to the multiplexer.

20. The method of claim 19, wherein the optical apparatus further comprises a demultiplexer and second protection optics, the method further comprising:
outputting, from the demultiplexer, a plurality of wavelengths; and
forwarding, using the second protection optics, a wavelength from the demultiplexer to one of the one or more redundant optical transceivers instead of the first primary optical transceiver based on the detecting.
